(19) United States
(12) Patent Application Publication
(10) Pub. No.: US 2026/0039808 A1
(43) Pub. Date: Feb. 5, 2026

(54) ENCODING AND DECODING METHODS AND APPARATUSES, CODEC, BITSTREAM, DEVICE, AND STORAGE MEDIUM

(71) Applicant: GUANGDONG OPPO MOBILE TELECOMMUNICATIONS CORP., LTD., Dongguan (CN)

(72) Inventor: Luhang XU, Dongguan (CN)

(21) Appl. No.: 19/351,676

(22) Filed: Oct. 7, 2025

Related U.S. Application Data
(63) Continuation of application No. PCT/CN2023/088181, filed on Apr. 13, 2023.

(51) Int. Cl. H04N 19/11; H04N 19/167; H04N 19/186

(52) U.S. Cl. CPC H04N 19/11; H04N 19/167; H04N 19/186

(57) ABSTRACT

Provided are codec methods and apparatuses, codec, bitstream, device, storage medium. The encoding method includes: determining a first candidate list, sorting candidate cross-component prediction models therein in ascending order of prediction errors of the models or a sum of prediction errors within a model group to which the models belong; selecting from the first candidate list a first cross-component prediction model of a first color component, performing intra prediction on the first color component of a current block according to the first cross-component prediction model and a reconstruction value of a second color component of the current block to obtain a first intra predicted value; determining a first residual value of the first color component according to the first intra predicted value and a sample value of the first color component; generating a bitstream according to the first residual value and an index value of the first cross-component prediction model.

### CROSS-REFERENCE TO RELATED APPLICATION

This application is a continuation application of International Patent Application No. PCT/CN2023/088181 filed on Apr. 13, 2023, the entire content of which is incorporated herein by reference.

### TECHNICAL FIELD

Embodiments of the present disclosure relate to video picture technology, and relate to, but are not limited to, encoding and decoding methods and apparatuses, a codec, a bitstream, a device, and a storage medium.

### BACKGROUND

Digital video compression technology is mainly used to compress huge digital video data to facilitate transmission and storage. With the proliferation of Internet videos and people's increased higher demands for the video definition, although existing digital video compression standards can save a lot of video data, it is still necessary to pursue better digital video compression technology to reduce the bandwidth and traffic pressure in digital video transmissions.

### SUMMARY

In view of this, encoding and decoding methods and apparatuses, a codec, a bitstream, a device, and a storage medium provided by the embodiments of the present disclosure can save the bitstream overhead of an index value of a selected cross-component prediction model, thereby reducing the bandwidth and traffic pressure in digital video transmission. The encoding and decoding methods and apparatuses, the codec, the bitstream, the device, and the storage medium provided by the embodiments of the present disclosure are implemented as follows.

According to an aspect of the embodiments of the present disclosure, there is provided an encoding method applied to an encoder. The method includes following operations. A first candidate list is determined. Candidate cross-component prediction models in the first candidate list are sorted in ascending order of either prediction errors of the candidate cross- component prediction models or a sum of prediction errors within a model group to which the candidate cross-component prediction models belong. A first cross-component prediction model for a first color component is selected from the first candidate list, and intra prediction is performed on the first color component of a current block based on the first cross-component prediction model and a reconstructed value of a second color component of the current block to obtain a first intra predicted value. A first residual value of the first color component of the current block is determined based on the first intra predicted value and a sample value of the first color component of the current block. A bitstream is generated based on the first residual value of the current block and an index value of the first cross-component prediction model in the first candidate list.

According to an aspect of the embodiments of the present disclosure, there is provided a decoding method applied to a decoder. The method includes following operations. A bitstream is parsed to obtain a first residual value of a first color component of a current block and an index value of a first cross-component prediction model in a first candidate list. The first candidate list is determined. Candidate cross-component prediction models in the first candidate list are sorted in ascending order of either prediction errors of the candidate cross-component prediction models or a sum of prediction errors within a model group to which the candidate cross-component prediction models belong. The first cross-component prediction model is determined based on the first candidate list and the index value of the first cross-component prediction model in the first candidate list. Intra prediction is performed on the first color component of the current block based on the first cross-component prediction model and a reconstructed value of a second color component of the current block to obtain a first intra predicted value. A reconstructed value of the first color component of the current block is determined based on the first intra predicted value and the first residual value.

According to an aspect of the embodiments of the present disclosure, there is provided an encoding apparatus applied to an encoder. The device includes a first determining module, a selecting module, a first prediction module, a second determining module, and an encoding module. The first determining module is configured to determine a first candidate list, candidate cross-component prediction models in the first candidate list being sorted in ascending order of either prediction errors of the candidate cross-component prediction models or a sum of prediction errors within a model group to which the candidate cross-component prediction models belong. The selecting module is configured to select a first cross-component prediction model for a first color component from the first candidate list. The first prediction module is configured to perform intra prediction on the first color component of the current block based on the first cross-component prediction model and a reconstructed value of a second color component of the current block to obtain a first intra predicted value. The second determining module is configured to determine a first residual value of the first color component of the current block based on the first intra predicted value and a sample value of the first color component of the current block. The encoding module is configured to generate a bitstream based on the first residual value of the current block and an index value of the first cross-component prediction model in the first candidate list.

According to an aspect of the embodiments of the present disclosure, there is provided an encoder including a first memory and a first processor. The first memory is configured to store a computer program executable on the first processor, and the first processor is configured to perform the encoding method in the embodiments of the present disclosure when executing the computer program.

According to an aspect of the embodiments of the present disclosure, there is provided a bitstream obtained by using the encoding method in the embodiments of the present disclosure.

According to an aspect of the embodiments of the present disclosure, there is provided a decoding apparatus applied to a decoder. The device includes a decoding module, a third determining module, a fourth determining module, a second prediction module, and a fifth determining module. The decoding module is configured to parse a bitstream to obtain a first residual value of a first color component of a current block and an index value of a first cross-component prediction model in a first candidate list. The third determining module is configured to determine the first candidate list, candidate cross-component prediction models in the first candidate list being sorted in ascending order of either prediction errors of the candidate cross-component prediction models or a sum of prediction errors within a model group to which the candidate cross-component prediction models belong. The fourth determining module is configured to determine the first cross-component prediction model based on the first candidate list and the index value of the first cross-component prediction model in the first candidate list. The second prediction module is configured to perform intra prediction on the first color component of the current block based on the first cross-component prediction model and a reconstructed value of a second color component of the current block to obtain a first intra predicted value. The fifth determining module is configured to determine a reconstructed value of the first color component of the current block based on the first intra predicted value and the first residual value.

According to an aspect of the embodiments of the present disclosure, there is provided a decoder including a second memory and a second processor. The second memory is configured to store a computer program executable on the second processor, and the second processor is configured to perform the decoding method in the embodiments of the present disclosure when executing the computer program.

According to an aspect of the embodiments of the present disclosure, there is provided an electronic device including a processor and a computer-readable storage medium. The processor is applicable to execute a computer program; and the computer-readable storage medium having stored thereon a computer program which, when executed by the processor, implements the encoding method in the embodiments of the present disclosure is implemented, or implements the decoding method in the embodiments of the present disclosure is implemented.

According to an aspect of the embodiments of the present disclosure, there is provided a computer-readable storage medium having stored thereon a computer program which, when executed by the processor, implements the encoding method in the embodiments of the present disclosure, or implements the decoding method in the embodiments of the present disclosure.

In the embodiments of the present disclosure, the candidate cross-component prediction models in the first candidate list are sorted in ascending order of either the prediction errors of the candidate cross-component prediction models or a sum of prediction errors within a model group to which the candidate cross-component prediction models belong. In this way, since candidate cross-component prediction models with smaller prediction errors are more likely to be selected to perform intra prediction, ranking such candidate cross-component prediction models with smaller prediction errors ahead of those with larger prediction errors is beneficial to save the bitstream overhead of the index value of the selected candidate cross-component prediction model (i.e., the first cross-component prediction model), thereby reducing bandwidth and traffic pressure in digital video transmission.

### BRIEF DESCRIPTION OF THE DRAWINGS

The accompanying drawings, which are incorporated in and constitute a part of the description, illustrate embodiments consistent with the disclosure and, together with the description, serve to explain the technical solutions in the embodiments of the disclosure. Obviously, the drawings as described below only illustrate some embodiments of the disclosure, and other drawings may be obtained based on these drawings by those skilled in the art without creative efforts.

The flowcharts illustrated in the drawings are merely illustrative and do not necessarily include all contents and operations/steps, nor do they necessarily need to be performed in the described order. For example, some operations/steps may also be broken down, and some operations/steps may be merged or partially merged, so the actual execution order may change depending on the actual situation.

FIG. 1 is a basic flowchart of a video codec.

FIG. 2 is an implementation flowchart of an encoding method according to an embodiment of the present disclosure.

FIG. 3 is a schematic diagram of a 5-tap cross-shaped filter according to an embodiment of the present disclosure.

FIG. 4 is a schematic diagram of a reconstructed area for deriving filter coefficients according to an embodiment of the present disclosure.

FIG. 5 is an implementation flowchart of an encoding method according to an embodiment of the present disclosure.

FIG. 6 is a schematic diagram of neighboring positions of a current block according to an embodiment of the present disclosure.

FIG. 7 is an implementation flowchart of a determination method of a first candidate list according to an embodiment of the present disclosure.

FIG. 8 is an implementation flowchart of a decoding method according to an embodiment of the present disclosure.

FIG. 9 is an implementation flowchart of a decoding method according to an embodiment of the present disclosure.

FIG. 10A is a schematic diagram of positions of reconstructed luma samples and reconstructed chroma samples for deriving α and β according to an embodiment of the present disclosure.

FIG. 10B is a schematic diagram of constructing a linear relationship between a luma sample (Y) and a chroma sample (C).

FIG. 10C is a schematic diagram of dividing samples into two groups according to a threshold and deriving two groups of linear models.

FIG. 11 is a schematic diagram of four kinds of Sobel operators used in a Gradient linear model (GLM) to obtain a gradient according to an embodiment of the present disclosure.

FIG. 12 is a schematic diagram of templates of a Cb component and a Cr component for resorting according to an embodiment of the present disclosure.

FIG. 13 is a schematic structural diagram of an encoding apparatus according to an embodiment of the present disclosure.

FIG. 14 is a schematic structural diagram of a decoding apparatus according to an embodiment of the present disclosure.

FIG. 15 is a schematic structural diagram of an encoder according to an embodiment of the present disclosure.

FIG. 16 is a schematic structural diagram of a decoder according to an embodiment of the present disclosure.

### DETAILED DESCRIPTION

In order to make the objectives, technical solutions and advantages of the embodiments of the present disclosure clearer, technical solutions of the embodiments of the present disclosure will be further described in detail below in combination with the accompanying drawings of the embodiments of the present disclosure. The following embodiments are used to illustrate the present disclosure, but are not intended to limit the scope of the present disclosure.

Unless otherwise defined, all technical and scientific terms used herein have the same meaning as commonly understood by those skilled in the technical field of the present disclosure. The terms used herein are only for the purpose of describing the present disclosure, and are not intended to limit the present disclosure.

In the following description, “some embodiments”, “this/the embodiment”, “embodiments of the present disclosure”, examples and the like describe a subset of all possible embodiments. It is to be understood that “some embodiments” may be the same subset or different subsets of all possible embodiments, and may be combined with each other without conflict.

The terms “first\ second\ third” appearing in embodiments of the present disclosure is merely used for illustrating and distinguishing the described objects and represents neither a specific sequence nor a special limitation on the number of devices in the embodiments of the present disclosure, which do not constitute any limitation on the embodiments of the present disclosure.

The “current block” appearing in the embodiments of the present disclosure may be understood as a “current Coding Unit (CU)”, a “current Prediction Unit (PU)”, or the like.

The “pixel” appearing in the embodiments of the present disclosure may be understood as “sample”.

The codec architecture and the service scenario described in the embodiments of the present disclosure are for more clearly describing the technical solutions of the embodiments of the present disclosure, and do not constitute a limitation on the technical solutions provided by the embodiments of the present disclosure. It is apparent to those skilled in the art that as the codec architecture evolves and new service scenarios emerge, the technical solutions provided by the embodiments of the present disclosure are equally applicable to similar technical problems.

Video compression includes multiple modules, such as, intra prediction (i.e. the spatial-domain compression) and/or inter prediction (i.e. the time-domain compression) modules for reducing or extracting intrinsic redundancy of a video, and modules for transform, quantization, inverse quantization and inverse transform of residual information, and loop filtering and entropy coding modules for improving subjective and objective reconstruction quality. Most of major video compression standards describe the block-based compression technology. One video slice, one picture, or a series of pictures will be partitioned into Coding Trec Units (CTUs), and further partitioned into blocks with Coding Unit (CU) as the unit. An intra block is predicted by taking pixels/samples around the block as references, and an inter block is predicted by referring to information of spatial neighboring blocks and reference information of other pictures. In contrast to the prediction information, residual information is transformed, quantized, and entropy encoded on a block basis into a bitstream. These technologies are described in standards and are implemented in various fields related to video compression.

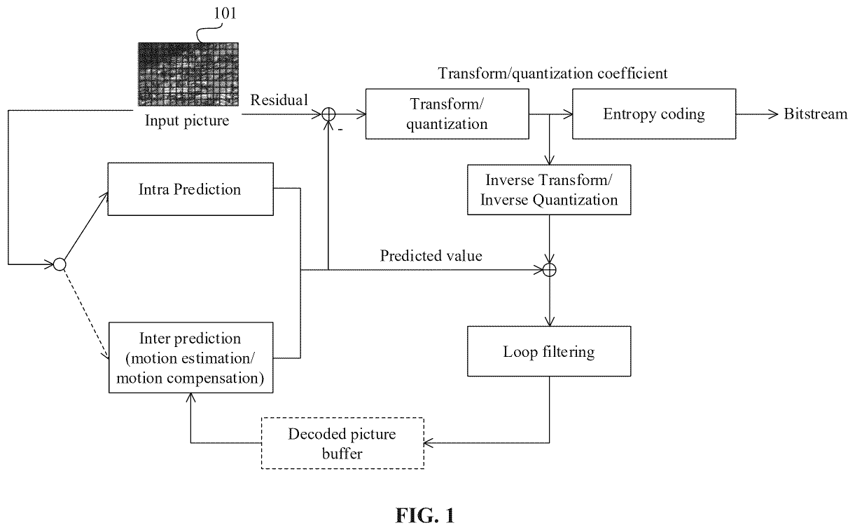

A basic flow of a video codec is illustrated in FIG. 1. At the encoding end, one picture 101 is partitioned into blocks, intra prediction or inter prediction is performed on a current block to generate a prediction block of the current block, the prediction block is subtracted from the original block of the current block to obtain a residual block, transform and quantization is performed on the residual block to obtain a quantization coefficient matrix, and entropy coding is performed on the quantization coefficient matrix to generate a bitstream. At the decoding end (not illustrated in the figure), intra prediction or inter prediction is used for the current block to generate the prediction block of the current block, on the other hand, the bitstream is parsed to obtain the quantization coefficient matrix, inverse quantization and inverse transform are performed on the quantization coefficient matrix to obtain the residual block, and the prediction block is added into the residual block to obtain a reconstructed block. The reconstructed block constitutes a reconstructed picture, and loop filtering on a picture or block basis is performed on the reconstructed picture to obtain a decoded picture. The encoding end also needs to adopt similar operations as the decoding end to obtain the decoded picture. At the encoding end, the obtained decoded picture may be used as a reference picture for inter prediction for a subsequent picture. The encoding-end determined block partitioning information, and parameter information or mode information such as prediction, transform, quantization, entropy coding, loop filtering and so on, may be carried in the bitstream when necessary. The decoding end determines the same block partitioning information, and parameter information or mode information such as prediction, transform, quantization, entropy coding, loop filtering and etc., as those of the encoding end by parsing and analyzing according to the existing information, so as to ensure that the decoded picture obtained by the encoding end is the same as the decoded picture obtained by the decoding end. The decoded picture obtained at the encoding end is also commonly called a reconstructed picture. When prediction is performed, the current block may be partitioned into prediction units; and when transform is performed, the current block may be partitioned into transform units. Partitioning into prediction units may be different from partitioning into transform units.

The foregoing is the basic flow of the video codec under a block-based hybrid coding framework, and with the development of technology, some modules or operations in the framework or the flow may be optimized. The present disclosure is applicable to this basic flow of the video codec under the block-based hybrid coding framework, but is not limited to this framework and flow described above. Those skilled in the art can appreciate that as the codec evolves and new service scenarios emerge, the methods provided by the embodiments of the present disclosure are equally applicable to similar technical problems.

It is to be understood that there is a strong spatial correlation between adjacent parts or adjacent pixels/adjacent samples in a picture, and intra prediction is a method of performing prediction on a current block by using reconstructed pixels/samples around the current block as references. In order to remove redundancy between different color channels, a cross-component intra prediction mode is proposed. For example, when a chroma component of the current block is predicted by using a reconstructed luma block, it is necessary to construct a linear or nonlinear relationship between luma and chroma based on a reconstructed value of a luma component and a reconstructed value of the chroma component when prediction is performed.

An embodiment of the present disclosure provides an encoding method applied to an encoder. FIG. 2 is an implementation flowchart of an encoding method according to an embodiment of the present disclosure. As illustrated in FIG. 2, the method includes the following operation 201 to operation 205.

In operation 201, a first candidate list is determined, where candidate cross-component prediction models in the first candidate list are sorted in ascending order of either prediction errors of the candidate cross-component prediction models or a sum of prediction errors within a model group to which the candidate cross-component prediction models belong.

It is to be understood that in the first candidate list, an index value may correspond to a candidate cross-component prediction model in the first candidate list. In other embodiments, in the first candidate list, an index value may also correspond to a group of candidate cross-component prediction models in the first candidate list. The first candidate list includes N candidate cross-component prediction model group(s), and each candidate cross-component prediction model group includes candidate cross-component prediction models for the first color component and candidate cross-component prediction models for a third color component, where N is greater than or equal to 1. In some embodiments, N is a fixed value, e.g., N=6.

Exemplarily, in some embodiments, both the first color component and the third color component are chroma components. For example, the first color component is a blue (denoted as Cb) chroma component and the third color component is a red (denoted as Cr) chroma component. For another example, the first color component is a red (denoted as Cr) chroma component, and the third color component is a blue (denoted as Cb) chroma component.

Whether the candidate cross-component prediction models for various color components in the first candidate list are sorted separately or sorted on a group basis is not limited in the embodiments of the present disclosure.

In some embodiments, the candidate cross-component prediction models for the first color component in the first candidate list are sorted in ascending order of prediction errors of the candidate cross-component prediction models for the first color component; and/or the candidate cross-component prediction models for the third color component in the first candidate list are sorted in ascending order of prediction errors of the candidate cross-component prediction models for the third color component. That is to say, the candidate cross-component prediction models for the first color component are sorted separately from the candidate cross-component prediction models for the third color component in the first candidate list.

In other embodiments, the candidate cross-component prediction model groups in the first candidate list are sorted in ascending order of a sum of prediction errors of the candidate cross-component prediction models for the first color component and prediction errors of the candidate cross-component prediction models for the third color component in each candidate cross-component prediction model group. It is to be understood that a group of candidate cross-component prediction models includes the candidate cross-component prediction models for the first color component and the candidate cross-component prediction models for the third color component, and the candidate cross-component prediction models in the first candidate list are arranged in order on a group basis. A group of candidate cross-component prediction models inherits cross-component prediction models for different color components of the same reconstructed block for intra prediction.

It is to be understood that the prediction error of the candidate cross-component prediction model refers to an error obtained when the candidate cross-component prediction model is used to perform intra prediction on a template area of the current block, and the template area may be a reconstructed arca. Specifically, reference may be made to the description of operation 502 in the following embodiments.

In operation 202, a first cross-component prediction model for a first color component is selected from the first candidate list.

How the encoder selects the first cross-component prediction model is not limited in the embodiments of the present disclosure, as long as a valid bitstream satisfying requirements can be generated after encoding. In some embodiments, a candidate cross-component prediction model having the smallest rate-distortion cost may be selected as the first cross-component prediction model from the first candidate list based on rate-distortion optimization.

In operation 203, intra prediction is performed on the first color component of the current block based on the first cross-component prediction model and a reconstructed value of a second color component of the current block to obtain a first intra predicted value.

Exemplarily, in some embodiments, the second color component is the luma component and the first color component is the chroma component.

It is to be understood that the methods of calculating the first intra predicted value may be different when the first cross-component prediction model has different types.

For example, the first cross-component prediction model is a Cross Component Linear Model (CCLM) model, and the expression of the model is illustrated in the following formula (1):

$${pred}_{c} ( i , j ) = α \cdot {rec}_{L}^{′} ( i , j ) + β \qquad ( 1 )$$

In formula (1), pred_{C}(i, j) represents a first intra predicted value of the chroma component with coordinate (i, j) in the current block, rec_{L}′(i, j) represents a reconstructed value of a luma component with the coordinate (i, j) in the current block. The reconstructed value of the luma component is obtained by down sampling reconstructed values of luma components of at least two samples, and α and β are parameters of the model, i.e., linear parameters.

In some embodiments, α and β may be determined based on reconstructed values of chroma components of neighboring areas and/or non-neighboring areas of the current block and reconstructed values of luma components of the corresponding areas.

In the ECM, α and β may be derived using the least square method, and the calculation formulas are illustrated as the following formula (2) and formula (3):

$$α = \frac{I \times {{\sum }_{i = 0}}^{I} {Rec}_{C} ( i ) \times {Rec}_{L}^{′} ( i ) - {{\sum }_{i = 0}}^{I} {Rec}_{C} ( i ) \times {{\sum }_{i = 0}}^{I} {Rec}_{L}^{′} ( i )}{I \times {{\sum }_{i = 0}}^{I} {Rec}_{L}^{′} ( i ) \times {Rec}_{L}^{′} ( i ) - {( {\sum }_{i = 0}^{I} {Rec}_{L}^{′} ( i ) )}^{2}} \frac{{A}_{1}}{{A}_{2}} ; \qquad ( 2 )$$

$$β = \frac{{{\sum }^{I}}_{i = 0} {Rec}_{C} ( i ) - α \times {{\sum }_{i = 0}}^{I} {Rec}_{L}^{′} ( i )}{I} ; \qquad ( 3 )$$

in formula (2) and formula (3), I represents the number of reconstructed samples, Re_{C}((i) represents a reconstructed value of a chroma component of the i-th sample, and Rec_{L}′(i) represents a reconstructed value of a luma component of the i-th sample.

For another example, the first cross-component prediction model is a Multi-model Linear Model (MMLM) model. The MMLM model is similar to the CCLM model, except that the MMLM model allows two CCLM models to be derived for one current block. Which one of the two CCLM models is used is controlled by a first threshold (denoted as Threshold). The first threshold may be determined based on the reconstructed values of luma components of the neighboring areas and/or the non-neighboring areas of the current block. For example, the first threshold is equal to an average of the reconstructed values of the luma components of neighboring areas and/or non-neighboring areas of the current block. The MMLM model may be expressed as the following formula (4):

$$\{ \begin{matrix}{Pred}_{C} ( i , j ) = {α}_{1} \times {Rec}_{L}^{′} ( i , j ) + {β}_{1} if {Rec}_{L}^{′} ( i , j ) \leq Threshold \\ {Pred}_{C} ( i , j ) = {α}_{2} \times {Rec}_{L}^{′} ( i , j ) + {β}_{2} if {Rec}_{L}^{′} ( i , j ) > Threshold\end{matrix} ; \qquad ( 4 )$$

where the calculation methods of α₁, and α₂ are the same as the calculation method of α in the formula (2), except that: α₁ is calculated using reconstructed values less than or equal to Threshold among the reconstructed values of the luma components in the neighboring areas and/or non-neighboring areas of the current block and reconstructed values of chroma components at positions corresponding to samples having luma components with reconstructed values less than or equal to Threshold; accordingly, β₁ is calculated using reconstructed values less than or equal to Threshold among the reconstructed values of the luma components in the neighboring areas and/or non-neighboring areas of the current block and reconstructed values of chroma components at positions corresponding to samples having luma components with reconstructed values less than or equal to Threshold; α₂ is calculated using reconstructed values greater than Threshold among the reconstructed values of the luma components in the neighboring areas and/or non-neighboring areas of the current block and reconstructed values of chroma components at positions corresponding to samples having luma components with reconstructed values greater than Threshold; and accordingly, β2 is calculated using reconstructed values greater than Threshold among the reconstructed values of the luma components in the neighboring areas and/or non-neighboring areas of the current block and reconstructed values of chroma components at positions corresponding to samples having the luma components with reconstructed values greater than Threshold.

In the prediction using the MMLM model, in the case where Rec′_{L}(i, j) is less than or equal to the first threshold, the current sample (i, j) is predicted using Pred_{C}(i, j)=α₁×Rec′_{L}(i, j)+β₁; and in the case where Rec′_{L}(i, j) is greater than the first threshold, the current sample (i, j) is predicted using Pred_{C}((i, j)=α₂×Rec′_{L}(i, j)+β₂.

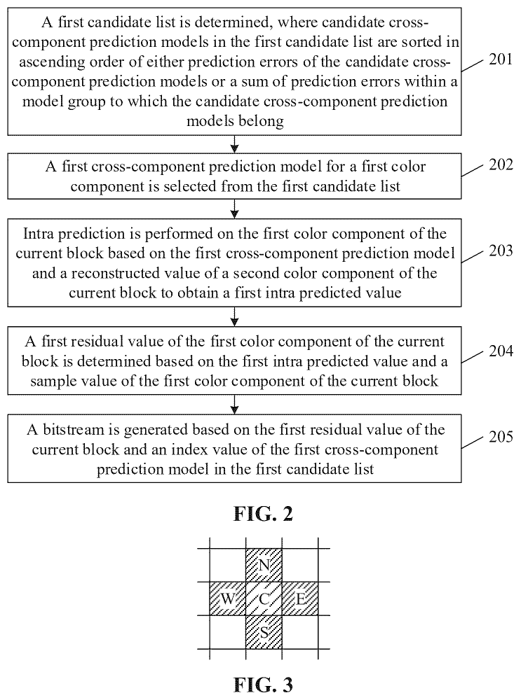

For another example, the first cross-component prediction model is the CCCM model, and the model parameters of the CCCM model are no longer simple α and β, but a group of filter parameters. The filter parameter of the CCCM model is a 7-tap filter including a 5-tap cross-shaped filter, a nonlinear term and a bias term. As illustrated in FIG. 3, the input of the 5-tap cross-shaped filter includes a Center (denoted as C) luma sample (which is a down-sampled luma sample at the position corresponding to the current chroma prediction position), an above (or north (denoted as N)) luma sample, a below (or South (denoted as S)) luma sample, a left (or West (denoted as W)) luma sample, and a right (or East (denoted as E)) luma sample.

As illustrated in the following formula (5), the nonlinear term P is determined by the luma input sample C at the center position and a bit precision bitDepth of the chroma component of the current block:

$$P = ( C \times C + ( 1 ≪ ( bitDepth - 1 ) ) ) ≫ bitDepth ; \qquad ( 5 )$$

for example, when the bit precision of the chroma component of the current block is 10 bits, P=(C×C+512)>>10.

The bias term B is set in the CCCM to be (1<<(bitDepth−1)). For example, for a content with the bit precision of the chroma component of the current block being 10 bits, B=512.

As illustrated in the following formula (6), the CCCM-based first intra predicted value predChromaVal may be determined according to the adaptively acquired 7-tap filter coefficient {c₀, . . . , C₆} and the reconstructed luma value of the input sample:

$$predChromaVal = c 0 C + c 1 N + c 2 S + c 3 E + c 4 W + c 5 P + c 6 B \qquad ( 6 )$$

The acquisition of the filter coefficients is described as follows.

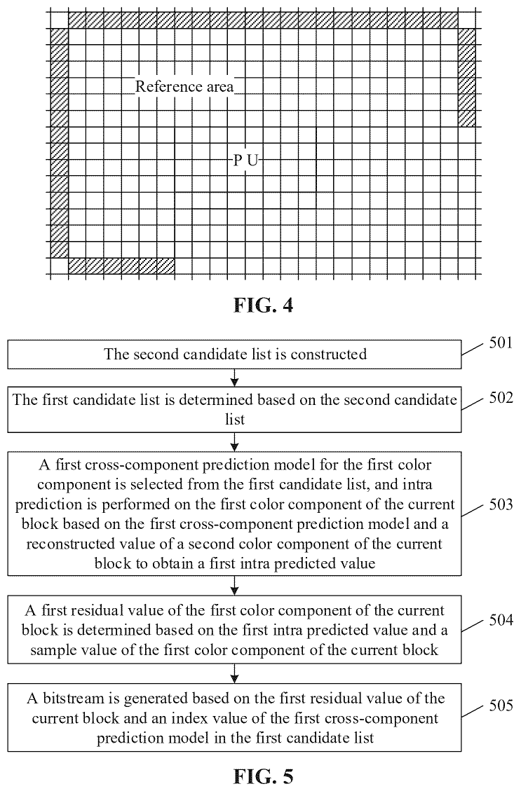

The filter coefficients are obtained by minimizing the mean square error between the total predicted chroma values and the reconstructed chroma values of reconstructed areas. As illustrated in FIG. 4, the reconstructed areas of the chroma component of the current block include 6 rows and 6 columns of reconstructed chroma values around the current block. When a position where reconstruction has been not completed exists in the reconstructed areas, the value at this position is filled with a reconstructed chroma value.

The process of calculating the minimized mean square error is as follows:
1. an autocorrelation matrix of input luma samples and a cross-correlation vector of input luma samples and output chroma samples are acquired; and
2. the autocorrelation matrix is subjected to LDL decomposition, and the final filter coefficients are obtained by back-substitution.

In the calculation of the autocorrelation matrix, since the value of the used input luma sample is relatively large, higher accuracy is required when convolution filter coefficients are calculated. Therefore, in the CCCM, corresponding offset values offsetLuma, offsetCb and offsetCr are required to be subtracted respectively from the input luma sample and the output chroma sample. The reconstructed luma value and the predicted chroma value outside the above-left of the current block are used as the bias, therefore, the inputs of the CCCM become as follows:

$${C}^{′} = C - offsetLuma$$

$${N}^{′} = N - offsetLuma$$

$${S}^{′} = S - offsetLuma$$

$${E}^{′} = E - offsetLuma$$

$${W}^{′} = W - offsetLuma$$

$${P}^{′} = nonLinear ( {C}^{′} )$$

$$B = midValue = 1 ≪ ( bitDepth - 1 )$$

The predicted chroma value predChromaVal (i.e., the first intra predicted value) is calculated by the following formula (7), where offsetChroma is an offset of the Cb component or the Cr component:

$$predChromaVal = c 0 {C}^{′} + c 1 {N}^{′} + c 2 {S}^{′} + c 3 {E}^{′} + c 4 {W}^{′} + c 5 {P}^{′} + c 6 B + offsetChroma . \qquad ( 7 )$$

The CCCM also supports that there are two groups of filter coefficients for one block. Similar to the MMLM, for example, the use of a certain group of coefficients is controlled according to a corresponding configured threshold.

Since the parameters c₀, c₆ and possibly existing corresponding thresholds as well as the second group of parameters of the CCCM are derived, they do not need to be parsed from the bitstream at the decoding end.

In operation 204, a first residual value of the first color component of the current block is determined based on the first intra predicted value and a sample value of the first color component of the current block.

In operation 205, a bitstream is generated based on the first residual value of the current block and an index value of the first cross-component prediction model in the first candidate list.

In some embodiments, the encoder may perform the cross-component intra prediction on the chroma component of the current block by using the CCMerge mode by default, or may determine, based on a preset rule, whether to perform the cross-component intra prediction on the chroma component of the current block by using the CCMerge mode. It is to be understood that in the case where the encoder determines to perform the intra prediction by using the CCMerge mode, the index value of the first cross-component prediction model in the first candidate list is signalled into a bitstream.

It is to be understood that in the embodiments of the present disclosure, the candidate cross-component prediction models recorded in the first candidate list are sorted in ascending order of either the prediction errors of the candidate cross-component prediction models or the sum of the prediction errors within a model group to which the candidate cross-component prediction models belongs. In this way, since the candidate cross-component prediction model with a small prediction error is more likely to be selected to perform the intra prediction, ranking the candidate cross-component prediction models with small prediction errors ahead of the candidate cross-component prediction models with large prediction errors is beneficial to save the bitstream overhead of the index value of the selected candidate cross-component prediction model (i.e., the first cross-component prediction model), thereby reducing bandwidth and traffic pressure in digital video transmission.

An embodiment of the present disclosure further provides an encoding method applied to an encoder. FIG. 5 is an implementation flowchart of an encoding method according to an embodiment of the present disclosure. As illustrated in FIG. 5, the method includes the following operation 501 to operation 505.

In operation 501, a second candidate list is constructed, where the second candidate list includes a plurality of candidate cross-component prediction model groups, each candidate cross-component prediction model group includes candidate cross-component prediction models for the first color component and/or candidate cross-component prediction models for a third color component; the plurality of candidate cross-component prediction model groups include: specific-slope CCLM models, and/or second cross-component prediction models for intra prediction for a first color component and/or a third color component of a neighboring position and/or a non-neighboring position of a current block.

In operation 502, the first candidate list is determined based on the second candidate list.

In operation 503, a first cross-component prediction model for the first color component is selected from the first candidate list, and intra prediction is performed on the first color component of the current block based on the first cross-component prediction model and a reconstructed value of a second color component of the current block to obtain a first intra predicted value.

In operation 504, a first residual value of the first color component of the current block is determined based on the first intra predicted value and a sample value of the first color component of the current block.

In operation 505, a bitstream is generated based on the first residual value of the current block and an index value of the first cross-component prediction model in the first candidate list.

In some embodiments, the encoder may perform the cross-component intra prediction on a chroma component of the current block by using the CCMerge mode by default, or may determine, based on a preset rule, whether to perform the cross-component intra prediction on the chroma component of the current block by using the CCMerge mode. It is to be understood that in a case where the encoder determines to perform the intra prediction by using the CCMerge mode, the index value of the first cross-component prediction model in the first candidate list is signalled via a bitstream.

Hereinafter, further optional embodiments of each of the aforementioned operations, related terms, and the like will be described.

In the operation 501, the second candidate list is constructed, where the second candidate list includes a plurality of candidate cross-component prediction model groups, each candidate cross-component prediction model group includes candidate cross-component prediction models for the first color component and/or candidate cross-component prediction models for a third color component; the a plurality of candidate cross-component prediction model groups include: specific-slope CCLM models, and/or second cross-component prediction models for intra prediction for a first color component and/or a third color component of a neighboring position and/or a non-neighboring position of the current block.

Furthermore, in some embodiments, the construction of the second candidate list may be implemented as follows. A group of second cross-component prediction models for intra prediction for the neighboring position and/or non-neighboring position of the current block is acquired, where the group of second cross-component prediction models includes: cross-component prediction models for the first color component and/or cross-component prediction models for the third color component.

De-duplication is performed on the obtained second cross-component prediction models to obtain second cross-component prediction models after de-duplication.

In a case where the number of groups of second cross-component prediction models after de-duplication is less than N, the second cross-component prediction models after de-duplication are used as candidate cross-component prediction models in the second candidate list, and the specific-slope CCLM models are filled into the second candidate list until there are N groups of candidate cross-component prediction models.

In a case where the number of the groups of second cross-component prediction models after de-duplication is equal to N, the second cross-component prediction models after de-duplication are used as candidate cross-component prediction models in the second candidate list.

In a case where the number of the groups of second cross-component prediction models after de-duplication is greater than N, the second cross-component prediction models after de-duplication are used as candidate cross-component prediction models in the second candidate list.

It is to be understood that the reason why it is necessary to perform the de-duplication on the obtained second cross-component prediction models is to enable the prediction models between any two groups of candidate cross-component prediction models recorded in the second candidate list to be different.

In the embodiments of the present disclosure, the number of groups of candidate cross-component prediction models in the second candidate list is not limited, which may be N or may be larger than N. In the case where the number of groups of candidate cross-component prediction models in the second candidate list is less than N, the specific-slope CCLM models may be filled into the second candidate list until there are N groups of candidate cross-component prediction models.

In some embodiments, the second candidate list includes one or more of: a CCLM model, a MMLM model, a Convolutional Cross Component Model (CCCM) model, and a Gradient linear model (GLM) model.

Exemplarily, the second candidate list is a CCMerge list. It is to be understood that in the CCMerge list, the second cross-component prediction models used to perform the intra prediction on the first color components and the third color components of the neighboring positions and/or the non-neighboring positions of the current block are recorded, and the second cross-component prediction models inherited from the neighboring positions and/or the non-neighboring positions are stored in the list without repetition. The cross-component prediction models in the CCMerge list may be one or more of the CCLM, the MMLM, the CCCM and the GLM. When the second cross-component prediction models are insufficient to fill the CCMerge list, default models are filled into the list until there are N groups of models. For example, the default models may be the specific-slope CCLM models, for example, the slope α is {0, ⅛, −⅛, 2/8, − 2/8, ⅜} in sequence, and β is obtained by the calculation method as described in the CCLM paragraph.

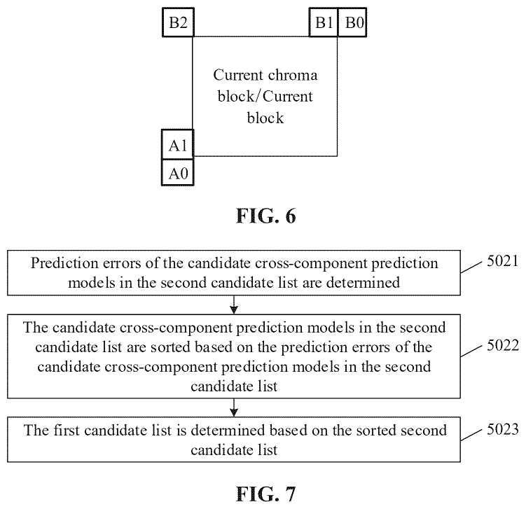

The neighboring positions of the current block are as illustrated in FIG. 6. When the second cross-component prediction models for the neighboring positions of the current block are obtained, the second cross-component prediction models for the positions B1, A1, B0, A0, and B2 may be accessed sequentially. The encoder may also acquire the second cross-component prediction models used by non-neighboring positions of the current block and add these models into the CCMerge list. The non-neighboring positions of the current block may be one or more non-neighboring positions that are located at above the current block, above-left of the current block, above-right of the current block, left of the current block, and/or bottom-right of the current block.

In operation 502, the first candidate list is determined based on the second candidate list.

It is to be understood that the candidate cross-component prediction models in the second candidate list may be arranged in a configured access order. Herein, the access order refers to the order of accessing the neighboring positions and/or non-neighboring positions of the current block. For example, when the second cross-component prediction models of the neighboring positions of the current block are obtained, the second cross-component prediction models for the positions B1, A1, B0, A0, and B2 may be accessed sequentially.

Based on the obtained second candidate list, the candidate cross-component prediction models in the second candidate list are resorted, and the first candidate list is determined based on the resorted second candidate list. Herein, “resorting” may also be understood as “sorting”, “sorting again”, or the like, and in short, means that the candidate cross- component prediction models in the second candidate list are resorted.

Specifically, in some embodiments, as illustrated in FIG. 7, the operation 502 may be implemented through following operation 5021 to operation 5023.

In operation 5021, prediction errors of the candidate cross-component prediction models in the second candidate list are determined.

In operation 5022, the candidate cross-component prediction models in the second candidate list are sorted based on the prediction errors of the candidate cross-component prediction models in the second candidate list.

In operation 5023, the first candidate list is determined based on the sorted second candidate list.

In the operation 5021, the prediction errors of the candidate cross-component prediction models in the second candidate list are determined.

It is to be understood that different color components have their respective candidate cross-component prediction models, and thus it is necessary to calculate the prediction errors of the candidate cross-component prediction models of the different color components.

Exemplarily, in some embodiments, the operation 5021 may be implemented as follows. The intra prediction is performed on the color component in a template area of the current block based on the candidate cross-component prediction model for the color component (the color component is the first color component or the third color component) in the second candidate list and a reconstructed value of a second color component in the template area of the current block to obtain a second intra predicted value. The prediction error of the candidate cross-component prediction model for the color component in the second candidate list is determined based on the second intra predicted value and a reconstructed value of the color component in the template area of the current block.

Exemplarily, in some embodiments, the template area of the current block includes an above neighboring template of the current block and/or a left neighboring template of the current block.

For example, the above neighboring template is an above neighboring row of the current block, and/or the left neighboring template is a left neighboring column of the current block.

It is to be understood that the template area of the current block includes a first sample for which reconstruction of the second color component has been not completed and/or a first sample for which reconstruction of the second color component has been completed.

In the case where the first sample for which reconstruction of the second color component has been not completed exists in the template area of the current block, the reconstructed value of the second color component of the first sample is filled with a reconstructed value of a second sample which is adjacent or non-adjacent to the first sample and for which the reconstruction of the second color component has been completed.

In some embodiments, in a case where reconstruction of the second color component has been not completed for each of all samples of the template area of the current block, the candidate cross-component prediction models in the second candidate list are not resorted, but the intra prediction is performed based on the second candidate list. For example, a third cross-component prediction model for the first color component is selected from the second candidate list, and the intra prediction is performed on the first color component of the current block based on the third cross-component prediction model and the reconstructed value of the second color component of the current block to obtain a third intra predicted value. A second residual value of the first color component of the current block is determined based on the third intra predicted value and the sample value of the first color component of the current block. The bitstream is generated based on the second residual value of the current block and an index value of the third cross-component prediction model in the second candidate list.

In the operation 5022, the candidate cross-component prediction models in the second candidate list are sorted based on the prediction errors of the candidate cross-component prediction models in the second candidate list.

In the embodiments of the present disclosure, when the sorting is performed, the candidate cross-component prediction models for different color components belonging to the same group may be sorted separately, or the candidate cross-component prediction model groups may be sorted on a group basis.

Exemplarily, in some embodiments, the operation 5022 may be implemented as follows. The candidate cross-component prediction models for the first color component in the second candidate list are sorted in ascending order of prediction errors of the candidate cross-component prediction models for the first color component in the second candidate list; and/or
the candidate cross-component prediction models for the third color component in the second candidate list are sorted in ascending order of prediction errors of the candidate cross-component prediction models for the third color component in the second candidate list.

Exemplarily, in some embodiments, the operation 5022 may also be implemented as follows. The candidate cross-component prediction model groups in the second candidate list are sorted in ascending order of a sum of prediction errors of candidate cross-component prediction model for the first color component and prediction errors of candidate cross- component prediction model for the third color component in each model group in the second candidate list.

Whether a part or all of parameters of each candidate cross-component prediction model are recorded in the second candidate list is not limited in the embodiments of the present disclosure.

In some embodiments, in the case where the candidate cross-component prediction model for the color component in the second candidate list is a CCCM model, a part of parameters of the CCCM model is a filter parameter of the CCCM model; and the remaining part of parameters of the CCCM model include an offset value of the color component (e.g. aforementioned offsetCb or offsetCr) and an offset value of the second color component (e.g. aforementioned offsetLuma). The method further includes: the offset value of the color component is determined based on the reconstructed value of the color component of a neighboring block and/or a non-neighboring block of the current block; and the offset value of the second color component is determined based on the reconstructed value of the second color component of the neighboring block and/or the non-neighboring block of the current block.

Exemplarily, in some embodiments, the offset value of the color component is equal to an average of one or more reconstructed values of the color components of neighboring blocks and/or non-neighboring blocks of the current block; and the offset value of the second color component is equal to an average of one or more reconstructed values of the second color components of neighboring blocks and/or non-neighboring blocks of the current block.

For example, offsetChroma (e.g., offsetCb or offsetCr) may be obtained by averaging one or more reconstructed values of the reconstructed areas (e.g., reconstructed values of the above chroma component, above-left chroma component, left chroma component, bottom-left chroma component, and/or above-right chroma component of the current block) of the chroma component of the current block. Similarly, offsetLuma is obtained in the same method as the chroma offsetChroma based on the luma block at the position corresponding to the current chroma position.

In other embodiments, the second candidate list includes a part of parameters of the candidate cross-component prediction model for the color component. Based on this, the method further includes: a remaining part of parameters of the candidate cross-component prediction model for the color component is determined according to the part of parameters of the candidate cross-component prediction model for the color component in the second candidate list and a reconstructed value of a neighboring block or a non-neighboring block of the current block.

Exemplarily, in some embodiments, in the case where the candidate cross- component prediction model for the color component in the second candidate list is the CCLM model, the part of parameters of the candidate cross-component prediction model for the color component is the slope of the CCLM model. The calculation method of the remaining part of the parameters of the CCLM model (i.e., β) may refer to the aforementioned formula (3), which is not repeated herein.

Exemplarily, in some embodiments, in a case where the candidate cross-component prediction model for the color component in the second candidate list is an MMLM model, the part of parameters of the candidate cross-component prediction model for the color component include: a slope of a first CCLM model, a slope of a second CCLM model, and a first threshold in the MMLM model. The calculation method of the remaining part of the parameters of the first CCLM model and the second CCLM model (i.e., β) may refer to the aforementioned formula (3), which is not repeated herein.

For the use of the MMLM model, in some embodiments, in a case where a reconstructed value of a second color component of a sample to be predicted of the color component in the template area of the current block is less than or equal to the first threshold, the intra prediction is performed on a color component of the sample to be predicted based on the first CCLM model and the reconstructed value of the second color component of the sample to be predicted.

In a case where the reconstructed value of the second color component of the sample to be predicted of the color component in the template area of the current block is greater than the first threshold, the intra prediction is performed on the color component of the sample to be predicted based on the second CCLM model and the reconstructed value of the second color component of the sample to be predicted.

The rule for determining a prediction error is not limited in the embodiments of the present disclosure, and may be the followings.

Exemplarily, in some embodiments, the prediction error of the candidate cross-component prediction model for the color component in the second candidate list is equal to a Sum of Absolute Difference (SAD), a Sum of Absolute Transformed Difference (SATD), a Mean Squared Error (MSE), or a Sum of Squared Difference (SSD) between the second intra predicted value and the reconstructed value of the color component in the template area of the current block.

In the operation 5023, the first candidate list is determined based on the sorted second candidate list.

Furthermore, in some embodiments, in the case where the number of groups of the candidate cross-component prediction models in the second candidate list is equal to N, the first candidate list is the sorted second candidate list; and in the case where the number of groups of the candidate cross-component prediction models in the second candidate list is larger than N, top N candidate cross-component prediction model groups in the sorted second candidate list are reserved to obtain the first candidate list.

In the embodiments of the present disclosure, for any coding unit, the encoder may perform the intra prediction using the first candidate list. Of course, the encoder may also determine whether to use the first candidate list to perform the intra prediction according to the size of the current block and/or the type of the picture to which the current block belongs.

Exemplarily, in some embodiments, the first candidate list is determined in at least one of the following case (1) to case (3).
(1) The size of the current block is less than a second threshold.
(2) The size of the current block is greater than a third threshold, and the second threshold is greater than the third threshold.
(3) The type of the picture to which the current block belongs is an intra picture.

It is to be understood that a video sequence is classified into intra prediction pictures and inter prediction pictures according to different coding configurations, and all prediction blocks in the intra prediction picture are intra prediction blocks, but blocks in the inter prediction picture include both the intra prediction blocks and inter prediction blocks. Herein, the intra picture refers to a picture where all prediction blocks in the intra picture are the intra prediction blocks.

In some embodiments, the encoder may signal a first identifier, where the first identifier is used to identify whether sorting is used to perform the intra prediction on the current block, a coding tree unit where the current block is located, a slice where the current block is located, a picture where the current block is located, or a sequence where the current block is located. For example, the first identifier is equal to 0, which represents that the candidate cross-component prediction models are not sorted, i.e., the first candidate list is not used to perform decoding. For another example, the first identifier is equal to 1, which represents that the candidate cross-component prediction models are sorted, i.e., the first candidate list is used to perform decoding.

Accordingly, at the decoding end, when obtaining the first identifier when parsing the bitstream, the decoder determines, based on the first identifier, whether to sort the candidate cross-component prediction models. If the first identifier indicates that the candidate cross-component prediction models are sorted, the candidate cross-component prediction models are sorted to obtain the first candidate list, and then the across-component intra prediction is performed on the first color component of the current block based on the first candidate list.

In some embodiments, the encoder may also signal a second identifier, where the second identifier is used to identify whether template area-based sorting is used.

It is to be understood that the second identifier is an overall control identifier, i.e., the template area-based sorting includes not only the sorting of candidate cross-component prediction models, but also other scenarios where the template area-based sorting is required to implement the sorting.

Accordingly, at the decoding end, when obtaining the second identifier when parsing the bitstream, the decoder determines, according to the second identifier, whether to use template area-based sorting. If the second identifier indicates that the template area-based sorting is used, the candidate cross-component prediction models are sorted to obtain the first candidate list, and then the across-component intra prediction is performed on the first color component of the current block based on the first candidate list.

An embodiment of the present disclosure further provides a decoding method applied to a decoder. FIG. 8 is an implementation flowchart of a decoding method according to an embodiment of the present disclosure. As illustrated in FIG. 8, the method includes the following operation 801 to operation 805.

In operation 801, a bitstream is parsed to obtain a first residual value of a first color component of a current block and an index value of a first cross-component prediction model in a first candidate list.

In a possible implementation, the bitstream carries an identifier indicating whether a CCMerge mode is used, and when the identifier indicates that the CCMerge mode is used, the decoder performs the following operation 802 to operation 805; otherwise, the decoder adopts other methods to determine a reconstructed value of the current block.

In operation 802, the first candidate list is determined, where candidate cross-component prediction models in the first candidate list are sorted in ascending order of either prediction errors of the candidate cross-component prediction models or a sum of prediction errors within a model group to which the candidate cross-component prediction models belong.

In some embodiments, the first candidate list includes N candidate cross-component prediction model groups, and each candidate cross-component prediction model group includes candidate cross-component prediction models for the first color component and candidate cross-component prediction models for a third color component.

Exemplarily, in some embodiments, the first color component and the third color component are chroma components and the second color component is a luma component.

Furthermore, in some embodiments, the candidate cross-component prediction models for the first color component in the first candidate list are sorted in ascending order of prediction errors of the candidate cross-component prediction models for the first color component; and/or the candidate cross-component prediction models for the third color component in the first candidate list are sorted in ascending order of prediction errors of the candidate cross-component prediction models for the third color component.

Furthermore, in other embodiments, the candidate cross-component prediction model groups in the first candidate list are sorted in ascending order of a sum of prediction errors of the candidate cross-component prediction models for the first color component and prediction errors of the candidate cross-component prediction models for the third color component in each candidate cross-component prediction model group.

Furthermore, in some embodiments, the determination of the first candidate list may be implemented through operation 902 and operation 903 of the following embodiments.

It is to be noted that, in the embodiments of the present disclosure, the determination method of the first candidate list in the decoding method is the same as the determination method of the first candidate list in the encoding method, and therefore, technical details not described in the embodiments of the decoding method can be understood by referring to the description of the embodiments of the encoding method of the present disclosure.

In operation 803, the first cross-component prediction model is determined based on the first candidate list and the index value of the first cross-component prediction model in the first candidate list.

In operation 804, intra prediction is performed on the first color component of the current block based on the first cross-component prediction model and a reconstructed value of a second color component of the current block to obtain a first intra predicted value.

In operation 805, a reconstructed value of the first color component of the current block is determined based on the first intra predicted value and the first residual value.

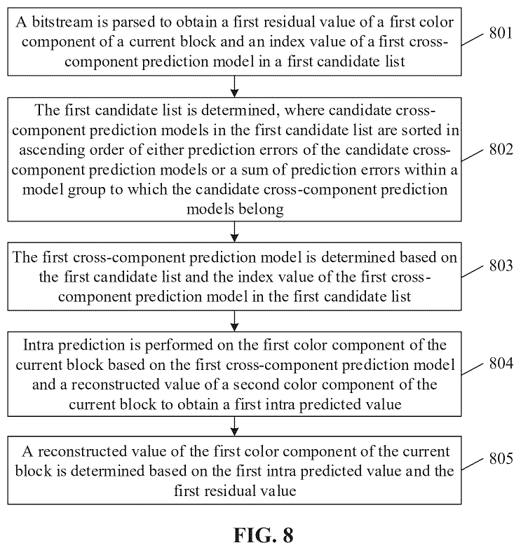

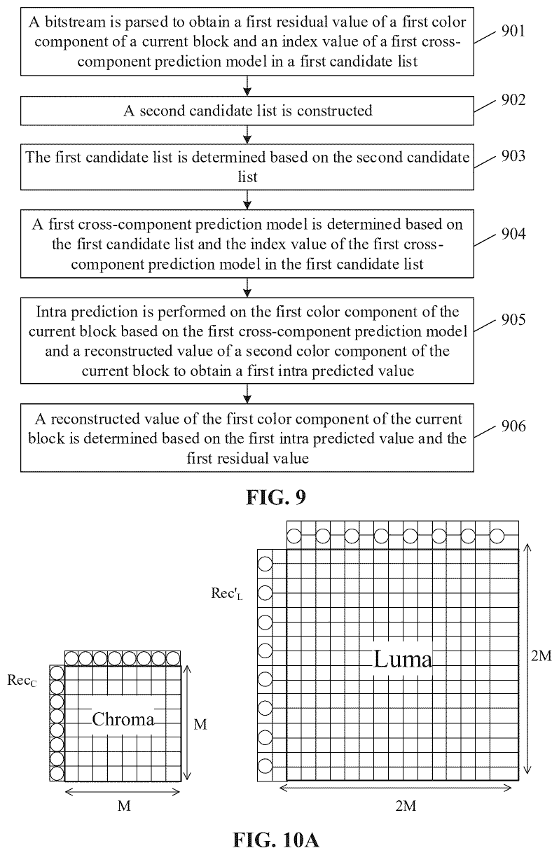

An embodiment of the present disclosure further provides a decoding method. FIG. 9 is an implementation flowchart of a decoding method according to an embodiment of the present disclosure. As illustrated in FIG. 9, the method includes the following operation 901 to operation 906.

In operation 901, a bitstream is parsed to obtain a first residual value of a first color component of a current block and an index value of a first cross-component prediction model in a first candidate list.

In operation 902, a second candidate list is constructed.

Herein, the second candidate list includes a plurality of candidate cross-component prediction model groups, each candidate cross-component prediction model group includes candidate cross-component prediction models for the first color component and/or candidate cross-component prediction models for a third color component; the plurality of candidate cross-component prediction model groups include: specific-slope CCLM models, and/or second cross-component prediction models for intra prediction for a first color component and/or a third color component of a neighboring position and/or a non-neighboring position of the current block.

Exemplarily, in some embodiments, the first color component and third color component are the chroma components and the second color component is the luma component.

In some embodiments, the second candidate list may be constructed as follows. A group of second cross-component prediction models for intra prediction for a neighboring position and/or a non-neighboring position of the current block is acquired, where the group of second cross-component prediction models includes: cross-component prediction models for the first color component and/or cross-component prediction models for the third color component.

De-duplication is performed on the obtained one or more groups of second cross-component prediction models to obtain second cross-component prediction models after de-duplication.

In a case where the number of the group of the second cross-component prediction models after de-duplication is less than N, the second cross-component prediction models after de-duplication are used as candidate cross-component prediction models in the second candidate list, and specific-slope CCLM models are filled into the second candidate list until there are N groups of candidate cross-component prediction models.

In a case where the number of the groups of second cross-component prediction models after de-duplication is equal to N, the second cross-component prediction models after de-duplication are used as candidate cross-component prediction models in the second candidate list.

In a case where the number of the groups of second cross-component prediction models after de-duplication is greater than N, the second cross-component prediction models after de-duplication are used as candidate cross-component prediction models in the second candidate list.

In some embodiments, the second candidate list includes one or more of: a CCLM model, a MMLM model, a CCCM model, and a GLM model.

In operation 903, the first candidate list is determined based on the second candidate list.

Furthermore, in some embodiments, the decoder may implement the operation 903 as follows. The prediction errors of the candidate cross-component prediction models in the second candidate list are determined; the candidate cross-component prediction models in the second candidate list are sorted based on the prediction errors of the candidate cross-component prediction models in the second candidate list; and the first candidate list is determined based on the sorted second candidate list.

Furthermore, in some embodiments, the operation that a prediction error of a candidate cross-component prediction model for a color component in the second candidate list is determined includes: the intra prediction is performed on the color component in a template area of the current block based on the candidate cross-component prediction model for the color component in the second candidate list and a reconstructed value of a second color component in the template area of the current block to obtain a second intra predicted value; and the prediction error of the candidate cross-component prediction model for the color component in the second candidate list is determined based on the second intra predicted value and a reconstructed value of the color component in the template area of the current block.

Exemplarily, in some embodiments, the template area of the current block includes an above neighboring template of the current block and/or a left neighboring template of the current block. For example, the above neighboring template is an above neighboring row of the current block, and/or the left neighboring template is a left neighboring column of the current block.

In some embodiments, a first sample for which reconstruction of the second color component has been not completed exists in the template area of the current block, the reconstructed value of the second color component of the first sample is filled with a reconstructed value of a second sample which is adjacent or non-adjacent to the first sample and for which the reconstruction of the second color component has been completed. In a case where reconstruction of the second color component has been not completed for each of all samples of the template area of the current block, the resorting technology is not used, but the cross-component intra prediction is performed based on the second candidate list. Accordingly, the bitstream carries a second residual value of the current block and an index value of a third cross-component prediction model in the second candidate list. In this case, the decoder parses the bitstream to obtain the second residual value and the index value of the third cross-component prediction model in the second candidate list. The third cross-component prediction model is determined based on the second candidate list and the index value of the third cross-component prediction model in the second candidate list. The intra prediction is performed on the first color component of the current block based on the third cross-component prediction model and a reconstructed value of a second color component of the current block to obtain a third intra predicted value. A reconstructed value of the first color component of the current block is determined based on the third intra predicted value and the second residual value.

Exemplarily, in some embodiments, the prediction error of the candidate cross-component prediction model for the color component in the second candidate list is equal to an SAD, an SATD, an MSE, or an SSD between the second intra predicted value and the reconstructed value of the color component in the template area of the current block.

In some embodiments, the operation that the candidate cross-component prediction models in the second candidate list are sorted based on the prediction errors of the candidate cross-component prediction models in the second candidate list includes: the candidate cross-component prediction models for the first color component in the second candidate list are sorted in ascending order of prediction errors of the candidate cross-component prediction models for the first color component in the second candidate list; and/or the candidate cross-component prediction models for the third color component in the second candidate list are sorted in ascending order of prediction errors of the candidate cross-component prediction models for the third color component in the second candidate list.

In other embodiments, the operation that the candidate cross-component prediction models in the second candidate list are sorted based on the prediction errors of the candidate cross-component prediction models in the second candidate list includes: the candidate cross-component prediction model groups in the second candidate list are sorted in ascending order of a sum of prediction errors of candidate cross-component prediction model for the first color component and prediction errors of candidate cross-component prediction model for the third color component in each model group in the second candidate list.

In some embodiments, in the case where the number of the candidate cross-component prediction model groups in the second candidate list is equal to N, the first candidate list is the sorted second candidate list; and in the case where the number of the candidate cross-component prediction model groups in the second candidate list is larger than N, top N candidate cross-component prediction model groups in the sorted second candidate list are reserved to obtain the first candidate list.

In some embodiments, the second candidate list includes a part of parameters of the candidate cross-component prediction model for the color component. In a case where the candidate cross-component prediction model for the color component in the second candidate list is a CCCM model, a part of parameters of the CCCM model is a filter parameter of the CCCM model; and a remaining part of parameters of the CCCM model includes an offset value of the color component and an offset value of the second color component. The method further includes: the offset value of the color component is determined based on the reconstructed value of the color component of a neighboring block and/or a non-neighboring block of the current block; and the offset value of the second color component is determined based on the reconstructed value of the second color component of a neighboring block and/or a non-neighboring block of the current block.

In other embodiments, the second candidate list includes a part of parameters of the candidate cross-component prediction model for the color component. The method further includes: a remaining part of parameters of the candidate cross-component prediction model for the color component is determined according to the part of parameters of the candidate cross-component prediction model for the color component in the second candidate list and a reconstructed value of a neighboring block or a non-neighboring block of the current block.

Exemplarily, in some embodiments, in the case where the candidate cross-component prediction model for the color component in the second candidate list is the CCLM model, the part of parameters of the candidate cross-component prediction model for the color component is the slope of the CCLM model.

Exemplarily, in some embodiments, in a case where the candidate cross-component prediction model for the color component in the second candidate list is an MMLM model, the part of parameters of the candidate cross-component prediction model for the color component include: a slope of a first CCLM model, a slope of a second CCLM model, and a first threshold in the MMLM model.

In a case where a reconstructed value of a second color component of a sample to be predicted of the color component in the template area of the current block is less than or equal to the first threshold, the intra prediction is performed on the color component of the sample to be predicted based on the first CCLM model and the reconstructed value of the second color component of the sample to be predicted.

In a case where the reconstructed value of the second color component of the sample to be predicted of the color component in the template area of the current block is greater than the first threshold, the intra prediction is performed on the color component of the sample to be predicted based on the second CCLM model and the reconstructed value of the second color component of the sample to be predicted.

In operation 904, a first cross-component prediction model is determined based on the first candidate list and the index value of the first cross-component prediction model in the first candidate list.

In operation 905, intra prediction is performed on the first color component of the current block based on the first cross-component prediction model and a reconstructed value of a second color component of the current block to obtain a first intra predicted value.

In operation 906, a reconstructed value of the first color component of the current block is determined based on the first intra predicted value and the first residual value.

In some embodiments, in a case where a size of the current block is less than a second threshold, and/or the size of the current block is greater than a third threshold, the first candidate list is determined, where the second threshold is greater than the third threshold.

In some embodiments, in a case where a type of a picture to which the current block belongs is an intra picture, the first candidate list is determined.

In some embodiments, the method further includes: the bitstream is parsed to obtain a first identifier, where the first identifier is used to identify whether sorting is used to perform the intra prediction on the current block, a coding tree unit where the current block is located, a slice where the current block is located, a picture where the current block is located, or a sequence where the current block is located.

In some embodiments, the method further includes: the bitstream is parsed to obtain a second identifier, where the second identifier is used to identify whether template area-based sorting is used.

It is to be noted that, in the embodiments of the present disclosure, the determination method of the first candidate list in the decoding method is the same as the determination method of the first candidate list in the encoding method, and therefore, technical details not described in the embodiments of the decoding method can be understood by referring to the description of the embodiments of the encoding method of the present disclosure.

It is to be understood that there is a strong spatial correlation between adjacent parts or adjacent pixels in a picture, and intra prediction is a method of performing prediction on a current block by using reconstructed samples/pixels around the current block as references. In order to remove redundancy between different color channels, the cross-component intra prediction mode is proposed. The idea of cross-component intra prediction mode is that a reconstructed luma block is used to predict a chroma component of the current block, it is necessary to construct a linear or nonlinear relationship between luma and chroma based on a value of a reconstructed luma pixel and a value of a reconstructed chroma pixel when prediction is performed. For example, a CCLM list, an MMLM list, a CCCM list, a GLM list, or a CCMerge list may be adopted to implement cross-component prediction for the current block.

The introduction of CCLM is as follows.

As illustrated in formula (8) below, in the CCLM, by using a simple linear relationship, a chroma pixel value is predicted using a reconstructed luma pixel value at corresponding position.

$${pred}_{C} ( i , j ) = α \cdot {rec}_{L}^{′} ( i , j ) + β ; \qquad ( 8 )$$

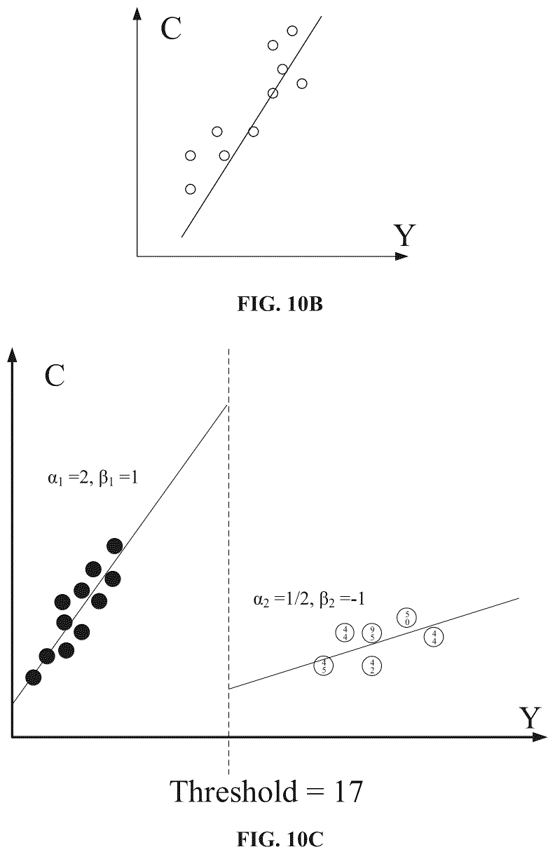

In formula (8), pred_{C}(i, j) represents an intra predicted value of the chroma component with coordinate (i, j) in the current block, rec_{L}′(i, j) represents a reconstructed value (i.e. a reconstructed luma pixel value) of the luma component with coordinate (i, j) subjected to down-sampling at the corresponding position in the current block. α and β are derived linear parameters that are derived from the reconstructed chroma pixel values around the current block (such as the chroma blocks illustrated in FIG. 10A) and the reconstructed luma pixel values around the corresponding position luma block (such as the luma blocks illustrated in FIG. 10A).

In the ECM, α and β may be derived by using the least square method, and the calculation formulas are illustrated as the following formula (9) and formula (10):

$$α = \frac{I \times {{\sum }_{i = 0}}^{I} {Rec}_{C} ( i ) \times {Rec}_{L}^{′} ( i ) - {{\sum }_{i = 0}}^{I} {Rec}_{C} ( i ) \times {{\sum }_{i = 0}}^{I} {Rec}_{L}^{′} ( i )}{I \times {{\sum }_{i = 0}}^{I} {Rec}_{L}^{′} ( i ) \times {Rec}_{L}^{′} ( i ) - {( {\sum }_{i = 0}^{I} {Rec}_{L}^{′} ( i ) )}^{2}} \frac{{A}_{1}}{{A}_{2}} ; \qquad ( 9 )$$

$$β = \frac{{{\sum }^{I}}_{i = 0} {Rec}_{C} ( i ) - α \times {{\sum }_{i = 0}}^{I} {Rec}_{L}^{′} ( i )}{I} ; \qquad ( 10 )$$

where I is the number of samples.

FIG. 10B is a schematic diagram of constructing a linear relationship between a luma sample (Y) and a chroma sample (C).

Since the linear parameters α and β of the CCLM are derived, they do not need to be parsed from the bitstream.

The introduction of MMLM is as follows.

The MMLM is similar to the CCLM, except that the MMLM allows two groups of linear models to be derived for one prediction block (i.e., the current block to be predicted). Which one of the two linear models is used for a prediction sample is controlled by the first threshold (Threshold), and the value of Threshold is obtained from the average of the reconstructed pixel values around the luma block at the corresponding position. The MMLM model is illustrated in the following formula (11). FIG. 10C is an example of dividing samples into two groups according to a threshold and deriving two groups of linear models.

$$\{ \begin{matrix}{Pred}_{C} [ x , y ] = {α}_{1} \times {Rec}_{L}^{′} [ x , y ] + {β}_{1} if {Rec}_{L}^{′} [ x , y ] \leq Threshold \\ {Pred}_{C} [ x , y ] = {α}_{2} \times {Rec}_{L}^{′} [ x , y ] + {β}_{2} if {Rec}_{L}^{′} [ x , y ] > Threshold\end{matrix} ; \qquad ( 11 )$$

in the MMLM-based prediction, the linear model used for the current prediction point is required to be determined according to whether the down-sampled reconstructed luma value at the corresponding prediction position is greater than the Threshold.

Since the Threshold, α₁, α₂, β₁ and β₂ of the MMLM are derived, they do not need to be parsed from the bitstream.

The introduction of the CCLM is as follows.

Similar to the CCLM model-based prediction method, the CCLM-based prediction method is also a process of predicting a pixel value of a chroma component based on a reconstructed pixel value of a luma component.

What CCCM derives is no longer the simple α and β, but a set of convolutional filter coefficients. The CCCM also supports that two groups of convolutional filter coefficients are derived for a block, and similarly, which group of convolutional filter coefficients is used is controlled by a second threshold.

The introduction of the convolutional filtering is as follows.

The convolutional filtering used by the CCCM model is a 7-tap filter including a 5-tap cross-shaped filter, a nonlinear term and a bias term. As illustrated in FIG. 3, the input of the 5-tap cross-shaped filter includes a Center (denoted as C) luma sample (which is a luma sample subjected to down sampling at the position corresponding to the current chroma prediction position), an above (or north (denoted as N)) luma sample, a below (or South (denoted as S)) luma sample, a left (or West (denoted as W)) luma sample, and a right (or East (denoted as E)) luma sample.

As illustrated in the following formula (12), the nonlinear term P is determined by the luma input sample C at the center position and a bit precision bitDepth of a pixel value of the current block to be predicted:

$$P = ( C \times C + ( 1 ≪ ( bitDepth - 1 ) ) ) ≫ bitDepth ; \qquad ( 12 )$$

for example, when the bit precision bitDepth of the pixel value of the current block to be predicted is 10 bits, P=(C×C+512)>>10.

The bias term B is set in the CCCM to be (1<<(bitDepth−1)). For example, for a content with a pixel precision of the block to be predicted being 10 bits, B=512.

As illustrated in the following formula (13), the CCCM-based predicted value predChroma Val may be determined according to the adaptively acquired 7-tap filter coefficient {c₀, . . . , c₆} and the input sample:

$$predChromaVal = c 0 C + c 1 N + c 2 S + c 3 E + c 4 W + c 5 P + c 6 B ; \qquad ( 13 )$$

The acquisition of the convolutional filter coefficients is described as follows.

The convolutional filter coefficients are obtained by minimizing the mean square error between the total predicted chroma values and the reconstructed values of reconstructed areas. As illustrated in FIG. 4, the reconstructed areas of the current chroma block include 6 rows and 6 columns of reconstructed pixel values around the current chroma block. When there is a position where reconstruction has been not completed in the reconstructed areas, the value at this position is filled with a reconstructed value.

The process of calculating the minimized mean square error is as follows:
1. an autocorrelation matrix of input luma samples and a cross-correlation vector of input luma samples and output chroma samples are acquired; and
2. the autocorrelation matrix is subjected to the LDL decomposition, and the final filter coefficients are obtained by back-substitution.

In the calculation of the autocorrelation matrix, since the value of the used input luma sample is relatively large, higher accuracy is required when convolution filter coefficients are calculated. Therefore, in the CCCM, corresponding offset values offsetLuma, offsetCb, and offsetCr are required to be subtracted respectively from the input luma sample and the output chroma sample. The reconstructed luma value and the predicted chroma value outside the above-left of the current block are used as the bias, therefore, the inputs of the CCCM become as follows:

$${C}^{′} = C - offsetLuma$$

$${N}^{′} = N - offsetLuma$$

$${S}^{′} = S - offsetLuma$$

$${E}^{′} = E - offsetLuma$$

$${W}^{′} = W - offsetLuma$$

$${P}^{′} = nonLinear ( {C}^{′} )$$

$$B = midValue = 1 ≪ ( bitDepth - 1 )$$

The predicted chroma value is calculated by the following formula (14), where offsetChroma is an offset of the Cb component and the Cr component, respectively:

$$predChromaVal = c 0 {C}^{′} + c 1 {N}^{′} + c 2 {S}^{′} + c 3 {E}^{′} + c 4 {W}^{′} + c 5 {P}^{′} + c 6 B + offsetChroma . \qquad ( 14 )$$

The CCCM also supports that there are two groups of filter coefficients for one block. Similar to the MMLM, for example, the use of a certain group of coefficients is controlled according to the Threshold.

Since the parameters c₀, c₆ and possibly existing corresponding Threshold as well as the second group of parameters in the CCCM are derived, they do not need to be parsed from the bitstream.

The introduction to GLM is as follows.

The GLM is an intra chroma cross-component prediction tool used in the format YUV4:2:0. In the ECM reference software, the GLM includes a two-parameter model and a three-parameter model.

Compared with the CCLM, the GLM uses gradient values of reconstructed luma samples and reconstructed chroma samples to derive a linear model. Specifically, for the two-parameter GLM, a predicted chroma value is calculated by the following formula, G represents a gradient value of a corresponding luma sample at a current position. The calculation methods of α and β are the same as those of the CCLM.

$$C = α \cdot G + β$$

For the three-parameter GLM, a predicted chroma value is calculated by both the luma sample corresponding to the current position and the gradient value of the corresponding luma sample. The calculation methods of α₀, α₁ and α₂ are the same as those of the CCLM. β=(1<<(bitDepth−1)). For example, for a content with a pixel precision of 10 bits of the block to be predicted, B=512.

$$C = {α}_{0} \cdot G + {α}_{1} \cdot L + {α}_{2} \cdot β$$

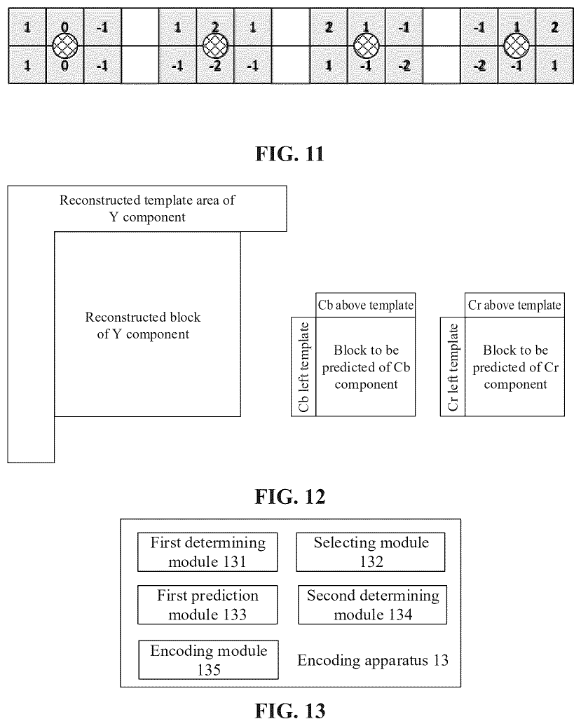

The gradient in the GLM is obtained by one of the four kinds of Sobel operators as illustrated in FIG. 11. Which Sobel operator is used to obtain the gradient value is determined by an flag obtained by parsing the bitstream.

Since the parameters of the GLM are derived, they do not need to be parsed from the bitstream.

The introduction of the CCMerge is as follows.

In the CCMerge, a CCMerge list having a length N (N=6) (i.e., an example of the second candidate list) is constructed by inheriting the cross-component prediction models of chroma components at neighboring positions or non-neighboring positions around the current block (i.e., the current block) and applying them to the prediction of the current block. The cross-component prediction models inherited from the surrounding blocks are stored in this list without repetition, and these cross-component prediction models may be one or several models of the CCLM, the MMLM, the CCCM and the GLM. When the models of the surrounding blocks are insufficient to fill the CCMerge list, default models may be used to fill the remaining list. Herein, the neighboring positions of the current block are illustrated in FIG. 6, and in the CCMerge, the positions of B1-→A1→B0→A0→B2 are sequentially accessed when the cross-component prediction models of the surrounding neighboring positions are acquired.

In the CCMerge, cross-component prediction models of non-neighboring positions may be further acquired, and the concept of the non-neighboring positions may also be used in inter merge, and the non-neighboring positions include some non-neighboring positions located at the above, above-left, above-right, left, and bottom-left of the current block.

The default model includes the default-slope CCLM. When the number of cross-component prediction model groups obtained from the neighboring positions and non-neighboring positions is less than N, the remaining list is filled with default-slope CCLMs. The default slope α is {0, ⅛, −⅛, 2/8, − 2/8, ⅜} in sequence, and β is calculated by using the aforementioned calculation method.

A block-level flag may be encoded and decoded to identify whether a CCMerge mode is selected. When the CCMerge is selected, it is further required to decode which model in the CCMerge list is selected. Truncated unary codes may be used to encode and decode model indexes.

In the list having the length N constructed by CCMerge, each index may correspond to a group of cross-component prediction models in the CCMerge list, and each group of models includes a model for predicting a blue chroma component Cb block and a model for predicting a red chroma component Cr block. When a selected model is determined by parsing indexes, both the cross-component prediction models for the Cb and the cross-component prediction models for the Cr are determined.

In the embodiments of the present disclosure, a method of resorting (which can also be understood as sorting) a list constructed by the CCMerge is provided. The cross-component prediction models for the Ch may be resorted separately from the cross-component prediction models for the Cr in the list. That is to say, after the resorting, the cross-component prediction models for the Cb obtained based on indexes and the cross-component prediction model for the Cr obtained based on indexes may inherit from blocks at different positions.

The resorting of the Cb component and the Cr component in the Merge lists is based on the cost of the predicted values and reconstructed values obtained by using the across-component prediction models in the list on the Cb template and the Cr template, respectively.

Exemplarily, the method of resorting the cross-component prediction models for the Cb component includes following operation 1 to operation 3.

In operation 1, candidate Cb cross-component prediction models at neighboring positions and non-neighboring positions are acquired, and when the number of the candidate Cb cross-component prediction models is less than N, default-slope CCLMs are used for filling until the number is equal to N.

In operation 2, each candidate Cb cross-component prediction model is used to acquire the input of the model from the reconstructed template area of the Y component, and the predicted value of the Cb template area is calculated. Herein, the schematic diagram of templates of the Cb component and Cr component used for resorting is illustrated in FIG. 12.

In operation 3, N N differences between predicted values and reconstructed values are taken as references, and the models with small difference values are sorted first.

The resorting method for the Cr component is the same as that for Cb, but the differences in the template area of the Cr are used as a basis for the sorting.

In some embodiments, in operation 1, when there are more than N candidate Ch cross-component prediction models at the neighboring positions and non-neighboring positions, more than N candidate Cb cross-component prediction models may be acquired, and only the top N candidate Cb cross-component prediction models with smaller prediction errors may be reserved in subsequent resorting.

In some embodiments, in operation 2, when the reconstructed template area of the Y component used as the input of the model includes pixels where reconstruction has been not completed, the nearest reconstructed pixel value may be used for filling, and when all the pixel values have not been subjected to the reconstruction, resorting may not be performed.

In some embodiments, in operation 3, the selected difference may be the sum of absolute difference (SAD). When the template area of the Cb includes rows and columns of the positive integer power of 2, such as 2, 4, 8 . . . , the sum of transformed difference (SATD) may be used as the difference.

In some embodiments, in operation 3, in order to reduce complexity, reconstructed areas of 1 row and 1 column may be used for the templates of the Cb and the Cr.

In some embodiments, since the cross-component mode that the CCMerge list may inherit may include the CCLM, the MMLM, the CCCM, and/or the GLM, the CCMerge list may inherit only some of the parameters of these models.

For example, in the CCLM, only the slope α may be inherited, and β may be adaptively calculated based on the current block.

For example, in the MMLM, only the α and Threshold of two models may be inherited, and β of two models may be adaptively calculated based on the current block.

For example, in the CCCM, the filter parameters of the CCCM may be inherited, and the luma offsetLuma and the chroma offsetChroma may be acquired based on the current block.

In some embodiments, the cross-component prediction models for the Cb and the Cr may be sorted together. That is to say, all groups of cross-component prediction models may be sorted according to the sum of differences (i.e. prediction error) of each group of models on the Ch template and Cr template, which means that each group of models inherits from the block at the same position.

In some embodiments, it is determined whether the resorting technology is used based on whether a current picture is an intra picture. When the current picture is an intra picture, resorting is allowed to be used.

In some embodiments, it may be determined whether the resorting technology is used based on the size of a current block. For example, when the size of the current block is less than N×M, and/or when the size of the current block is larger than P×Q, the resorting technology is used, where N, M, P, and Q are all positive integers.

In some embodiments, whether the resorting technology is used may be controlled through a syntax element (which is an example of the first identifier), such as a block-level syntax element, a coding tree unit-level syntax element, a slice-level syntax element, a picture-level syntax element, or a sequence-level syntax element.

In some embodiments, an identifier of the template-based sorting (i.e., an example of a second identifier) is set to control whether the template-based sorting technology can be used. In this case, whether to resort the CCMerge list may also be controlled by an overall flag.

In the embodiments of the present disclosure, a candidate list (such as a CCMerge list) is constructed for cross-component intra prediction modes, and cross-component prediction models inherited from surrounding blocks or default models are stored in the list, and the inherited models in the CCMerge list may include one or more of the CCLM, the MMLM model, the CCCM model, and the GLM model.

In the embodiments of the present disclosure, the models in the candidate list are resorted, and the resorting is performed based on the differences between the predicted values and the reconstructed values in each model in the template area of the Cb and template area of the Cr.

In the embodiments of the present disclosure, a list having a length greater than or equal to N may be constructed, and then only N groups of cross-component prediction models with smaller differences may be reserved during the resorting.

In the embodiments of the present disclosure, the models for the Cb and the models for the Cr may be sorted separately or together.

In the embodiments of the present disclosure, the sorting may be performed using the templates of Cb and Cr with one row and one column per template as well as the SAD as differences, thereby reducing computational complexity.

In the embodiments of the present disclosure, when a cross-component prediction model is inherited, only some parameters of the model may be inherited, and some parameters may be reserved and adaptively calculated based on the current block.

In the embodiments of the present disclosure, the size of the block, the type of the picture, the flag, and the like may be used to control whether to allow the resorting of the CCMerge list.

It is to be noted that although the various steps of the method in this disclosure are described in a specific order as illustrated in the drawings, this does not require or imply that these steps must be performed in such specific order, or that all the steps illustrated must be performed to achieve a desired result. Additionally or alternatively, some steps may be omitted, multiple steps may be combined into one step for execution, and/or one step may be decomposed into multiple steps for execution, etc. Alternatively, the steps in different embodiments are combined into a new technical solution.

Based on the foregoing embodiments, an embodiment of the present disclosure provides an encoding apparatus, and the encoding apparatus is applied to an encoder. FIG. 13 is a schematic structural diagram of the encoding apparatus according to an embodiment of the present disclosure. As illustrated in FIG. 13, the encoding apparatus 13 includes: a first determining module 131, a selecting module 132, a first prediction module 133, a second determining module 134, and an encoding module 135.

The first determining module 131 is configured to determine a first candidate list, where candidate cross-component prediction models in the first candidate list are sorted in ascending order of either prediction errors of the candidate cross-component prediction models or a sum of prediction errors within a model group to which the candidate cross-component prediction models belong.

The selecting module 132 is configured to select a first cross-component prediction model for a first color component from the first candidate list.

The first prediction module 133 is configured to perform intra prediction on the first color component of a current block based on the first cross-component prediction model and a reconstructed value of a second color component of the current block to obtain a first intra predicted value.

The second determining module 134 is configured to determine a first residual value of the first color component of the current block based on the first intra predicted value and a sample value of the first color component of the current block.

The encoding module 135 is configured to generate a bitstream based on the first residual value of the current block and an index value of the first cross-component prediction model in the first candidate list.

In some embodiments, the first candidate list includes N candidate cross-component prediction model groups, and each candidate cross-component prediction model group includes candidate cross-component prediction models for the first color component and candidate cross-component prediction models for a third color component, where N is greater than or equal to 1.

In some embodiments, the candidate cross-component prediction models for the first color component in the first candidate list are sorted in ascending order of prediction errors of the candidate cross-component prediction models for the first color component.

In some embodiments, the candidate cross-component prediction models for the third color component in the first candidate list are sorted in ascending order of prediction errors of the candidate cross-component prediction models for the third color component.

In some embodiments, the candidate cross-component prediction model groups in the first candidate list are sorted in ascending order of a sum of prediction errors of the candidate cross-component prediction models for the first color component and prediction errors of the candidate cross-component prediction models for the third color component in each candidate cross-component prediction model group.

In some embodiments, the first determining module 131 is configured to: construct a second candidate list; and determine the first candidate list based on the second candidate list, where the second candidate list includes a plurality of candidate cross-component prediction model groups, each candidate cross-component prediction model group includes candidate cross-component prediction models for the first color component and/or candidate cross-component prediction models for a third color component; and the plurality of candidate cross-component prediction model groups include: specific-slope CCLM models, and/or second cross-component prediction models for intra prediction for the first color component and/or the third color component of a neighboring position and/or a non-neighboring position of the current block.

In some embodiments, the second candidate list includes one or more of: a CCLM model, an MMLM model, a CCCM model, and a GLM model.

In some embodiments, the first determining module 131 is configured to: acquire a group of second cross-component prediction models for intra prediction for the neighboring position and/or non-neighboring position of the current block, where the group of second cross-component prediction models includes: cross-component prediction models for the first color component and/or cross-component prediction models for the third color component; in a case where the number of groups of second cross-component prediction models after de-duplication is less than N, use the second cross-component prediction models after de-duplication as candidate cross-component prediction models in the second candidate list, and fill the specific-slope CCLM models into the second candidate list until there are N groups of candidate cross-component prediction models; in a case where the number of the groups of second cross-component prediction models after de-duplication is equal to N, use the second cross-component prediction models after de-duplication as candidate cross-component prediction models in the second candidate list; and in a case where the number of the groups of second cross-component prediction models after de-duplication is greater than N, use the second cross-component prediction models after de-duplication as candidate cross-component prediction models in the second candidate list.

In some embodiments, the first determining module 131 is configured to: determine a prediction error of each candidate cross-component prediction model in the second candidate list; sort the candidate cross-component prediction models in the second candidate list based on the prediction errors of the candidate cross-component prediction models in the second candidate list; and determine the first candidate list based on the sorted second candidate list.

In some embodiments, the first determining module 131 is configured to: perform the intra prediction on a color component in a template area of the current block based on a candidate cross-component prediction model for the color component in the second candidate list and a reconstructed value of a second color component in the template area of the current block to obtain a second intra predicted value, where the color component refers to the first color component or the third color component; and determine the prediction error of the candidate cross-component prediction model for the color component in the second candidate list based on the second intra predicted value and a reconstructed value of the color component in the template area of the current block.

In some embodiments, the prediction error of the candidate cross-component prediction model for the color component in the second candidate list is equal to an SAD, an SATD, an MSE, or an SSD between the second intra predicted value and the reconstructed value of the color component in the template area of the current block.

In some embodiments, the template area of the current block includes an above neighboring template of the current block and/or a left neighboring template of the current block.

In some embodiments, the above neighboring template is an above neighboring row of the current block.

In some embodiments, the left neighboring template is a left neighboring column of the current block.

In some embodiments, in some embodiments, the first determining module 131 is further configured to: in a case where a first sample for which reconstruction of a second color component has been not completed exists in the template area of the current block, fill the reconstructed value of the second color component of the first sample with a reconstructed value of a second sample which is adjacent or non-adjacent to the first sample and for which the reconstruction of the second color component has not yet been completed.

In some embodiments, the selecting module 132 is further configured to: in a case where reconstruction of the second color component has been not completed for each of all samples in the template area of the current block, select a third cross-component prediction model for the first color component from the second candidate list. The first prediction module 133 is further configured to: perform intra prediction on the first color component of the current block based on the third cross-component prediction model and a reconstructed value of a second color component of the current block to obtain a third intra predicted value. The second determining module 134 is further configured to: determine a second residual value of the first color component of the current block based on the third intra predicted value and the sample value of the first color component of the current block. The encoding module 135 is further configured to: generate a bitstream based on the first residual value of the current block and an index value of the first cross-component prediction model in the first candidate list.

In some embodiments, the first determining module 131 is configured to: sort the candidate cross-component prediction models for the first color component in the second candidate list in ascending order of prediction errors of the candidate cross-component prediction models for the first color component in the second candidate list; and/or sort the candidate cross-component prediction models for the third color component in the second candidate list in ascending order of prediction errors of the candidate cross-component prediction models for the third color component in the second candidate list.

In other embodiments, the first determining module 131 is configured to: sort the candidate cross-component prediction model groups in the second candidate list in ascending order of a sum of prediction errors of candidate cross-component prediction model for the first color component and prediction errors of candidate cross-component prediction model for the third color component in each model group in the second candidate list.

In some embodiments, in a case where the number of the candidate cross-component prediction model groups in the second candidate list is equal to N, the first candidate list is the sorted second candidate list; and in a case where the number of the candidate cross-component prediction model groups in the second candidate list is larger than N, top N candidate cross-component prediction model groups in the sorted second candidate list are reserved to obtain the first candidate list.

In some embodiments, the second candidate list includes a part of parameters of the candidate cross-component prediction model for the color component. The first determining module 131 is further configured to: determine remaining part of parameters of the candidate cross-component prediction model for the color component according to the part of parameters of the candidate cross-component prediction model for the color component in the second candidate list and a reconstructed value of a neighboring block or a non-neighboring block of the current block.

In some embodiments, in a case where the candidate cross-component prediction model for the color component in the second candidate list is a CCLM model, the part of parameters of the candidate cross-component prediction model for the color component is a slope of the CCLM model.

In some embodiments, in a case where the candidate cross-component prediction model for the color component in the second candidate list is an MMLM model, the part of parameters of the candidate cross-component prediction model for the color component include: a slope of a first CCLM model, a slope of a second CCLM model, and a first threshold in the MMLM model. The first prediction module 133 is configured to: in a case where a reconstructed value of a second color component of a sample to be predicted of the color component in the template area of the current block is less than or equal to the first threshold, perform the intra prediction on a color component of the sample to be predicted based on the first CCLM model and the reconstructed value of the second color component of the sample to be predicted; and in a case where the reconstructed value of the second color component of the sample to be predicted of the color component in the template area of the current block is greater than the first threshold, perform the intra prediction on the color component of the sample to be predicted based on the second CCLM model and the reconstructed value of the second color component of the sample to be predicted.

In some embodiments, the second candidate list includes a part of parameters of the candidate cross-component prediction model for the color component. In a case where the candidate cross-component prediction model for the color component in the second candidate list is a CCCM model, a part of parameters of the CCCM model is a filter parameter of the CCCM model; a remaining part of parameters of the CCCM model includes an offset value of the color component and an offset value of the second color component. The first determining module 131 is further configured to: determine the offset value of the color component based on the reconstructed value of the color component of a neighboring block and/or a non-neighboring block of the current block; and determine the offset value of the second color component based on the reconstructed value of the second color component of a neighboring block and/or a non-neighboring block of the current block.

In some embodiments, the first determining module 131 is configured to: in a case where a size of the current block is less than a second threshold, and/or the size of the current block is greater than a third threshold, determine the first candidate list, where the second threshold is greater than the third threshold.

In some embodiments, the first determining module 131 is configured to: in a case where a type of a picture to which the current block belongs is an intra picture, determine the first candidate list.

In some embodiments, the encoding module 135 is further configured to: signal a first identifier, where the first identifier is used to identify whether sorting is used to perform the intra prediction on the current block, a coding tree unit where the current block is located, a slice where the current block is located, a picture where the current block is located, or a sequence where the current block is located.

In some embodiments, the encoding module 135 is further configured to: signal a second identifier, where the second identifier is used to identify whether template area-based sorting is used.

In some embodiments, the first color component and third color component are chroma components, and the second color component is a luma component.

The description of the above encoding apparatus embodiments is similar to the description of the above encoding method embodiments, and the above encoding apparatus embodiments have similar beneficial effect as the encoding method embodiments. Technical details not described in the encoding apparatus embodiments of the present disclosure are understood with reference to the description of the encoding method embodiments of the present disclosure.

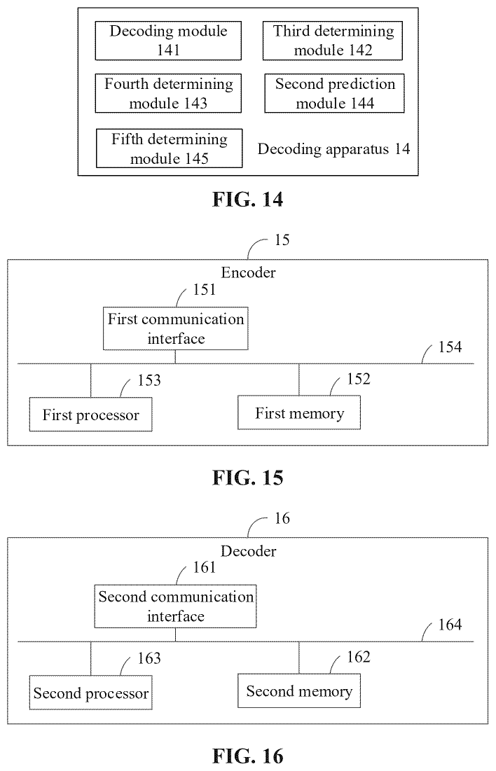

An embodiment of the present disclosure further provides a decoding apparatus applied to a decoder. FIG. 14 is schematic structural diagram of the decoding apparatus according to an embodiment of the present disclosure. As illustrated in FIG. 14, the decoding apparatus 14 includes: a decoding module 141, a third determining module 142, a fourth determining module 143, a second prediction module 144, and a fifth determining module 145.

The decoding module 141 is configured to parse a bitstream to obtain a first residual value of a first color component of a current block and an index value of a first cross-component prediction model in a first candidate list.

The third determining module 142 is configured to determine the first candidate list, where candidate cross-component prediction models in the first candidate list are sorted in ascending order of either prediction errors of the candidate cross-component prediction models or a sum of prediction errors within a model group to which the candidate cross-component prediction models belong.

The fourth determining module 143 is configured to determine the first cross-component prediction model based on the first candidate list and the index value of the first cross-component prediction model in the first candidate list.

The second prediction module 144 is configured to perform intra prediction on the first color component of the current block based on the first cross-component prediction model and a reconstructed value of a second color component of the current block to obtain a first intra predicted value.

The fifth determining module 145 is configured to determine a reconstructed value of the first color component of the current block based on the first intra predicted value and the first residual value.

In some embodiments, the third determining module 142 is configured to: construct a second candidate list; and determine the first candidate list based on the second candidate list, where the second candidate list includes a plurality of candidate cross-component prediction model groups, each candidate cross-component prediction model group includes candidate cross-component prediction models for the first color component and/or candidate cross-component prediction models for a third color component; and the plurality of candidate cross-component prediction model groups include: specific-slope CCLM models, and/or second cross-component prediction models for intra prediction for a first color component and/or a third color component of a neighboring position and/or a non-neighboring position of the current block.

In some embodiments, the third determining module 142 is configured to: acquire a group of second cross-component prediction models for intra prediction for the neighboring position and/or non-neighboring position of the current block, where the group of second cross-component prediction models includes: cross-component prediction models for the first color component and/or cross-component prediction models for the third color component; and in a case where the number of groups of second cross-component prediction models after de-duplication is less than N, use the second cross-component prediction models after de-duplication as candidate cross-component prediction models in the second candidate list, and fill the specific-slope CCLM models into the second candidate list until there are N groups of candidate cross-component prediction models; in a case where the number of the groups of second cross-component prediction models after de-duplication is equal to N, use the second cross-component prediction models after de-duplication as candidate cross-component prediction models in the second candidate list; and in a case where the number of the groups of second cross-component prediction models after de-duplication is greater than N, use the second cross-component prediction models after de-duplication as candidate cross-component prediction models in the second candidate list.

In some embodiments, the third determining module 142 is configured to: determine prediction errors of the candidate cross-component prediction models in the second candidate list; sort the candidate cross-component prediction models in the second candidate list based on the prediction errors of the candidate cross-component prediction models in the second candidate list; and determine the first candidate list based on the sorted second candidate list.

In some embodiments, the third determining module 142 is configured to: perform the intra prediction on a color component in a template area of the current block based on the candidate cross-component prediction model for the color component in the second candidate list and a reconstructed value of a second color component in the template area of the current block to obtain a second intra predicted value, where the color component refers to the first color component or the third color component; and determine the prediction error of the candidate cross-component prediction model for the color component in the second candidate list based on the second intra predicted value and a reconstructed value of the color component in the template area of the current block.

In some embodiments, the third determining module 142 is further configured to: in a case where a first sample for which reconstruction of the second color component has been not completed exists in the template area of the current block, fill the reconstructed value of the second color component of the first sample with a reconstructed value of a second sample which is adjacent or non-adjacent to the first sample and for which the reconstruction of the second color component has been completed.

In some embodiments, in a case where reconstruction of the second color component has been not completed for each of all samples in the template area of the current block, the bitstream carries a second residual value of the current block and an index value of a third cross-component prediction model in the second candidate list. The decoding module 141 is further configured to: parse the bitstream to obtain the second residual value and the index value of the third cross-component prediction model in the second candidate list. The fourth determining module 143 is further configured to: determine the third cross-component prediction model based on the second candidate list and the index value of the third cross-component prediction model in the second candidate list. The second prediction module 144 is further configured to: perform intra prediction on the first color component of the current block based on the third cross-component prediction model and the reconstructed value of the second color component of the current block to obtain a third intra predicted value. The fifth determining module 145 is further configured to: determine the reconstructed value of the first color component of the current block based on the third intra predicted value and the second residual value.

In some embodiments, the third determining module 142 is configured to: sort the candidate cross-component prediction models for the first color component in the second candidate list in ascending order of prediction errors of the candidate cross-component prediction models for the first color component in the second candidate list; and/or sort the candidate cross-component prediction models for the third color component in the second candidate list in ascending order of prediction errors of the candidate cross-component prediction models for the third color component in the second candidate list.

In some embodiments, the third determining module 142 is configured to: sort the candidate cross-component prediction model groups in the second candidate list in ascending order of a sum of prediction errors of candidate cross-component prediction model for the first color component and prediction errors of candidate cross-component prediction model for the third color component in each model group in the second candidate list.

In some embodiments, in a case where the number of the candidate cross-component prediction model groups in the second candidate list is equal to N, the first candidate list is the sorted second candidate list; and in a case where the number of the candidate cross-component prediction model groups in the second candidate list is larger than N, top N candidate cross-component prediction model groups in the sorted second candidate list are reserved to obtain the first candidate list.

In some embodiments, the second candidate list includes a part of parameters of the candidate cross-component prediction model for the color component. The third determining module 142 is further configured to: determine remaining part of parameters of the candidate cross-component prediction model for the color component according to the part of parameters of the candidate cross-component prediction model for the color component in the second candidate list and a reconstructed value of a neighboring block or a non-neighboring block of the current block.

In some embodiments, in a case where the candidate cross-component prediction model for the color component in the second candidate list is a CCLM model, the part of parameters of the candidate cross-component prediction model for the color component is a slope of the CCLM model.

In some embodiments, in a case where the candidate cross-component prediction model for the color component in the second candidate list is an MMLM model, the part of parameters of the candidate cross-component prediction model for the color component include: a slope of a first CCLM model, a slope of a second CCLM model, and a first threshold in the MMLM model. The second prediction module 144 is further configured to: in a case where a reconstructed value of a second color component of a sample to be predicted of the color component in the template area of the current block is less than or equal to the first threshold, perform the intra prediction on a color component of the sample to be predicted based on the first CCLM model and the reconstructed value of the second color component of the sample to be predicted; and in a case where the reconstructed value of the second color component of the sample to be predicted of the color component in the template area of the current block is greater than the first threshold, perform the intra prediction on the color component of the sample to be predicted based on the second CCLM model and the reconstructed value of the second color component of the sample to be predicted.

In some embodiments, the second candidate list includes a part of parameters of the candidate cross-component prediction model for the color component. In a case where the candidate cross-component prediction model for the color component in the second candidate list is a CCCM model, the part of parameters of the CCCM model is a filter parameter of the CCCM model; a remaining part of parameters of the CCCM model includes an offset value of the color component and an offset value of the second color component. The third determining module 142 is further configured to: determine the offset value of the color component based on the reconstructed value of the color component of a neighboring block and/or a non-neighboring block of the current block; and determine the offset value of the second color component based on the reconstructed value of the second color component of a neighboring block and/or a non-neighboring block of the current block.

In some embodiments, the third determining module 142 is configured to: in a case where a size of the current block is less than a second threshold, and/or the size of the current block is greater than a third threshold, determine the first candidate list, where the second threshold is greater than the third threshold.

In some embodiments, the third determining module 142 is configured to: in a case where a type of a picture to which the current block belongs is an intra picture, determine the first candidate list.

In some embodiments, the decoding module 141 is further configured to: parse the bitstream to obtain a first identifier, where the first identifier is used to identify whether sorting is used to perform the intra prediction on the current block, a coding tree unit where the current block is located, a slice where the current block is located, a picture where the current block is located, or a sequence where the current block is located.

In some embodiments, the decoding module 141 is further configured to: parse the bitstream to obtain a second identifier, where the second identifier is used to identify whether template area-based sorting is used.

The description of the above decoding apparatus embodiments is similar to the description of the above encoding/decoding method embodiments and the above decoding apparatus embodiments have similar beneficial effect as the encoding/decoding method embodiments. Technical details not disclosed in the decoding apparatus embodiments of the present disclosure are understood with reference to the description of the encoding/decoding method embodiments of the present disclosure.

It is to be noted that in the encoding/decoding apparatus in the embodiments of the present disclosure, is only schematic, division of the modules is schematic and is only logic function division, and other division manners may be adopted during practical implementation. In addition, functional units in various embodiments of the disclosure may be integrated into a processing unit, or each of the units may be physically separated, or two or more units may be integrated into a unit. The above integrated unit may be implemented in the form of not only a hardware but also a software functional unit. The above integrated unit may also be implemented in the form of a combination of the software and the hardware.

It is to be noted that in the embodiments of the present disclosure, if the aforementioned methods are implemented in the form of a software functional module and sold or used as an independent product, they may also be stored in a computer-readable storage medium. Based on such an understanding, the technical solutions according to embodiments of the disclosure in essence or the part contributing to the related art can be embodied in the form of a software product, and the computer software product is stored in a storage medium, which includes several instructions so that an electronic device implements all or part of the method according to respective embodiments of the disclosure. The aforementioned storage medium includes various media capable of storing a program code such as a USB disk, a mobile hard drive disk, a Read-Only Memory (ROM), a magnetic disk or an optical disk. In this way, the embodiments of the disclosure are not limited to any specific combinations of a hardware and a software.

An embodiment of the present disclosure provides a computer-readable storage medium having stored thereon a computer program which, when executed by a processor, implements the encoding method or decoding method in the embodiments of the present disclosure.

An embodiment of the present disclosure provides an encoder. As illustrated in FIG. 15, the encoder 15 may include a first communication interface 151, a first memory 152 and a first processor 153. The components are coupled together by a first bus system 154. It is to be understood that the first bus system 154 is used to implement the connection communication between these components. The first bus system 154 includes a power bus, a control bus and a status signal bus, in addition to a data bus. However, for the sake of clarity, the various buses are designated in FIG. 15 as the first bus system 154.

The first communication interface 151 is configured to receive and send signal in the process of sending and receiving information to and from other external network elements.

The first memory 152 is configured to store computer programs capable of running on the first processor 153.

The first processor is configured to perform the encoding method in the embodiments of the present disclosure when executing the computer program.

It can be understood that the first memory 152 in the embodiments of the present disclosure may be a volatile memory or a non-volatile memory, or may include both the volatile memory and the non-volatile memory. The non-volatile memory may be an ROM, a Programmable ROM (PROM), an Erasable PROM (EPROM), an Electrically EPROM (EEPROM) or a flash memory. The volatile memory may be a Random Access Memory (RAM) and is used as an external high-speed cache. It is exemplarily but unlimitedly described that RAMs in various forms may be adopted, such as a static RAM (SRAM), a dynamic RAM (DRAM), a Synchronous DDRAM (SDRAM), a double data rate SDRAM (DDR SDRAM), an Enhanced SDRAM (ESDRAM), a Synchlink DRAM (SLDRAM) and a Direct Rambus RAM (DR RAM). The first memory 152 of the systems and methods described in this specification includes but is not limited to these and any other proper types of memories.

The first processor 153 may be an integrated circuit chip with signal processing capacity. In the implementation process, various operations of the above methods may be completed by integrated logic circuits of hardware in the first processor 153 or instructions in the form of software. The above first processor 153 may be a general-purpose processor, a Digital Signal Processor (DSP), an Application Specific Integrated Circuit (ASIC), a Field Programmable Gate Array (FPGA), or other programmable logic devices, discrete gate or transistor logic devices, and discrete hardware components. Various methods, steps, and logical block diagrams disclosed in the embodiments of the disclosure may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software modules may be located in a mature storage medium in the art, such as a random access memory, a flash memory, a read-only memory, a programmable read-only memory or electrically erasable programmable memory, or a register. The storage medium is located in the first memory 152, and the first processor 153 reads information in the first memory 152 and completes the steps in the foregoing methods in combination with hardware of the processor.

It can be understood that the embodiments described herein may be implemented in hardware, software, firmware, middleware, microcode or a combination thereof. For the hardware implementation, the processing unit may be implemented in one or more ASICs, DSPs, DSPDs, PLDs, FPGAs, general purpose processors, controllers, microcontrollers, microprocessors, other electronic units or combinations thereof for performing the functions described herein. For software implementations, the technology described herein may be implemented by modules (e.g. procedures, functions, etc.) that perform the functions described herein. The software codes may be stored in memory and executed by a processor. The memory can be implemented in the processor or outside the processor.

Optionally, as another embodiment, the first processor 153 is further configured to perform the method described in any one of the aforementioned encoding embodiments when running the computer program.

An embodiment of the present disclosure provides a decoder. As illustrated in FIG. 16, the decoder 16 may include a second communication interface 161, a second memory 162 and a second processor 163. The components are coupled together by a second bus system 164. It is to be understood that the second bus system 164 is used to implement the connection communication between these components. The second bus system 164 includes a power bus, a control bus and a status signal bus, in addition to a data bus. However, for the sake of clarity, the various buses are designated in FIG. 16 as the second bus system 164. Herein,

The second communication interface 161 is configured to receive and send signal in the process of sending and receiving information to and from other external network elements.

The second memory 162 is configured to store a computer program capable of running on the second processor 163.

The second processor 163, when executing the computer program, is configured to perform the decoding method in the embodiments of the present disclosure.

It is to be understood that the second memory 162 has the hardware functions similar to those of the first memory 152, and the second processor 163 has the hardware functions similar to those of the first processor 153, which are not described in detail.

An embodiment of the present disclosure also provides a bitstream which is obtained by adopting the aforementioned encoding method.

An embodiment of the present disclosure provides an electronic device including a processor and a computer-readable storage medium. The processor is applicable to execute a computer program; and the computer-readable storage medium having stored thereon a computer program which, when executed by the processor, implements the encoding method and/or decoding method in the embodiments of the present disclosure. The electronic device may be various types of devices having video encoding and/or video decoding capabilities. For example, the electronic device is a mobile phone, a tablet computer, a laptop computer, a personal computer, a television, a projection device, or a monitoring device, or the like.

It is to be noted that the description of the above storage medium and device embodiments is similar to the description of the above method embodiments and the above storage medium and device embodiments have similar beneficial effect as the method embodiments. Technical details not described in the storage medium and device embodiments of the present disclosure are understood with reference to the description of the method embodiments of the present disclosure.

It should be understood that references to “one embodiment” or “an embodiment” or “some embodiments” throughout the specification mean that particular features, structures, or characteristics related to the embodiments are included in at least one embodiment of the present disclosure. Thus, the words “in one embodiment” or “in an embodiment” or “in some embodiments” appearing throughout the specification do not necessarily refer to the same embodiment. Furthermore, these particular features, structures or characteristics may be incorporated in one or more embodiments in any suitable manner. It should be understood that in various embodiments of the present disclosure, the sequence number(s) of the above processes do not imply the sequence(s) of execution, and the sequence of execution of each process should be determined according to the functions and internal logic thereof, and should not constitute any limitation on the implementation process of the embodiments of the present disclosure. The aforementioned embodiment numbers of the present disclosure are for the purpose of description only and do not represent the advantages or disadvantages of the embodiments. The above description of the various embodiments tends to emphasize differences between the various embodiments, and the similarities thereof may be referred to each other, and will not be repeated herein for the sake of brevity.

The term “and/or” represents only an association relationship describing associated objects and represents that three relationships may exist. For example, object A and/or object B may represent three conditions: i.e., independent existence of object A, existence of both object A and object B and independent existence of object B.

It is to be noted that, in this disclosure, the terms “include”, “contain” or any other variation thereof, are intended to cover a non-exclusive inclusion, such that a process, method, article, or device that includes a list of elements includes not only those elements but also other elements not expressly listed, or also includes elements inherent to such process, method, article, or device. Without more limitations, an element is defined by the statement “including a . . . ” that does not rule out there are additional identical elements in a process, method, article, or apparatus that includes the element.

In the several embodiments provided in the present disclosure, it is to be understood that the disclosed devices and method may be implemented in other modes. The embodiments described above are only schematic, and for example, division of the modules is only logic function division, and other division manners may be adopted during practical implementation. For example, multiple modules or components may be combined or integrated into another system, or some characteristics may be neglected or not executed. In addition, the displayed or discussed mutual couplings or direct couplings or communication connections between the components may be implemented by using some interfaces. The indirect couplings or communication connections between the devices or modules may be implemented in electronic, mechanical, or other forms.

The modules described as separate components may be or may not be physically separated, and the components displayed as modules may be or may not be physical modules, and may be located in one place or may be distributed over multiple network units. Some or all of the modules may be selected according to actual needs to achieve the objectives of the solutions of the embodiments of the present disclosure.

In addition, all the functional modules in various embodiments of the present disclosure may be integrated in one processing unit, or each module may be separately used as one unit, or two or more modules may be integrated in one unit. The above integrated modules may be implemented in the form of hardware or hardware plus software functional units.

A person of ordinary skill in the art may understand that all or part of the steps of the above method embodiments may be implemented by a program instructing relevant hardware, the above programs may be stored in a computer-readable storage medium, and when executed, the programs perform the operations of the above method embodiments. The above storage medium includes various media that may store program codes, such as a removable storage device, a ROM, a magnetic disk, or an optical disc.

Alternatively, if an integrated module according to embodiments of the disclosure is implemented in the form of a software functional module and sold or used as an independent product, it may also be stored in a computer-readable storage medium. Based on such an understanding, the technical solutions according to embodiments of the disclosure in essence or the part contributing to the related art can be embodied in the form of a software product, and the computer software product is stored in a storage medium, which includes several instructions so that an electronic device implements all or part of the method according to respective embodiments of the disclosure. The aforementioned storage medium includes various media capable of storing a program code such as a mobile storage device, a ROM, a magnetic disk, or an optical disk.

The methods disclosed in several method embodiments provided in the present disclosure can be arbitrarily combined without conflict to obtain new method embodiments.

The features disclosed in several product embodiments provided in the present disclosure can be arbitrarily combined without conflict to obtain new product embodiments.

The features disclosed in several methods or device embodiments provided in the present disclosure can be arbitrarily combined without conflict to obtain new method embodiments or device embodiments.

The above descriptions are merely implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure is defined by the scope of protection of the claims.

1. An encoding method, applied to an encoder, comprising:
determining a first candidate list, wherein candidate cross-component prediction models in the first candidate list are sorted in ascending order of either prediction errors of the candidate cross-component prediction models or a sum of prediction errors within a model group to which the candidate cross-component prediction models belong;
selecting a first cross-component prediction model for a first color component from the first candidate list, and performing intra prediction on the first color component of a current block based on the first cross-component prediction model and a reconstructed value of a second color component of the current block to obtain a first intra predicted value;
determining a first residual value of the first color component of the current block based on the first intra predicted value and a sample value of the first color component of the current block; and
generating a bitstream based on the first residual value of the current block and an index value of the first cross-component prediction model in the first candidate list.

2. The method of claim 1, wherein the first candidate list comprises N candidate cross-component prediction model groups, and each candidate cross-component prediction model group comprises candidate cross-component prediction models for the first color component and candidate cross-component prediction models for a third color component; where N is greater than 1.

3. The method of claim 2, wherein the candidate cross-component prediction models for the first color component in the first candidate list are sorted in ascending order of prediction errors of the candidate cross-component prediction models for the first color component.

4. The method of claim 2, wherein the candidate cross-component prediction models for the third color component in the first candidate list are sorted in ascending order of prediction errors of the candidate cross-component prediction models for the third color component.

5. The method of claim 2, wherein the candidate cross-component prediction model groups in the first candidate list are sorted in ascending order of a sum of prediction errors of the candidate cross-component prediction models for the first color component and prediction errors of the candidate cross-component prediction models for the third color component in each candidate cross-component prediction model group.

6. The method of claim 1, further comprising:
constructing a second candidate list; and determining the first candidate list based on the second candidate list,
wherein the second candidate list comprises a plurality of candidate cross-component prediction model groups, each candidate cross-component prediction model group comprises candidate cross-component prediction models for the first color component and/or candidate cross-component prediction models for a third color component; and the plurality of candidate cross-component prediction model groups include: specific-slope Cross Component Linear Model (CCLM) models, and/or second cross-component prediction models for intra prediction for a first color component and/or a third color component of a neighboring position and/or a non-neighboring position of the current block.

7. The method of claim 6, wherein the second candidate list comprises one or more of: a CCLM model, a Multi-model Linear Model (MMLM) model, a Convolutional cross component model (CCCM) model, and a Gradient linear model (GLM) model.

8. The method of claim 6, further comprising:
acquiring a group of second cross-component prediction models for intra prediction for the neighboring position and/or non-neighboring position of the current block, wherein the group of second cross-component prediction models comprises: cross-component prediction models for the first color component and/or cross-component prediction models for the third color component; and
in a case where a number of groups of second cross-component prediction models after de-duplication is less than N, using the second cross-component prediction models after de-duplication as candidate cross-component prediction models in the second candidate list, and filling the specific-slope CCLM models into the second candidate list until there are N groups of candidate cross-component prediction models.

9. The method of claim 8, further comprising:
in a case where the number of the groups of second cross-component prediction models after de-duplication is equal to N, using the second cross-component prediction models after de- duplication as candidate cross-component prediction models in the second candidate list.

10. A decoding method, applied to a decoder, the method comprising:
parsing a bitstream to obtain a first residual value of a first color component of a current block and an index value of a first cross-component prediction model in a first candidate list;
determining the first candidate list, wherein candidate cross-component prediction models in the first candidate list are sorted in ascending order of either prediction errors of the candidate cross-component prediction models or a sum of prediction errors within a model group to which the candidate cross-component prediction models belong;
determining the first cross-component prediction model based on the first candidate list and the index value of the first cross-component prediction model in the first candidate list;
performing intra prediction on the first color component of the current block based on the first cross-component prediction model and a reconstructed value of a second color component of the current block to obtain a first intra predicted value; and
determining a reconstructed value of the first color component of the current block based on the first intra predicted value and the first residual value.

11. The method of claim 10, wherein the first candidate list comprises N candidate cross-component prediction model groups, and each candidate cross-component prediction model group comprises candidate cross-component prediction models for the first color component and candidate cross-component prediction models for a third color component.

12. The method of claim 11, wherein the candidate cross-component prediction models for the first color component in the first candidate list are sorted in ascending order of prediction errors of the candidate cross-component prediction models for the first color component.

13. The method of claim 11, wherein the candidate cross-component prediction models for the third color component in the first candidate list are sorted in ascending order of prediction errors of the candidate cross-component prediction models for the third color component.

14. The method of claim 11, wherein the candidate cross-component prediction model groups in the first candidate list are sorted in ascending order of a sum of prediction errors of the candidate cross-component prediction models for the first color component and prediction errors of the candidate cross-component prediction models for the third color component in each candidate cross-component prediction model group.

15. The method of claim 10, further comprising:
constructing a second candidate list; and determining the first candidate list based on the second candidate list;
wherein the second candidate list comprises a plurality of candidate cross-component prediction model groups, each candidate cross-component prediction model group comprises candidate cross-component prediction models for the first color component and/or candidate cross-component prediction models for a third color component; and the plurality of candidate cross-component prediction model groups include: specific-slope Cross Component Linear Model (CCLM) models, and/or second cross-component prediction models for intra prediction for a first color component and/or a third color component of a neighboring position and/or a non-neighboring position of the current block.

16. The method of claim 15, wherein the second candidate list comprises one or more of: a CCLM model, a Multi-model Linear Model (MMLM) model, a Convolutional cross component model (CCCM) model, and a Gradient linear model (GLM) model.

17. The method of claim 15, further comprising:
acquiring a group of second cross-component prediction models for intra prediction for the neighboring position and/or non-neighboring position of the current block, wherein the group of second cross-component prediction models comprises: cross-component prediction models for the first color component and/or cross-component prediction models for the third color component; and
in a case where a number of groups of second cross-component prediction models after de-duplication is less than N, using the second cross-component prediction models after de-duplication as candidate cross-component prediction models in the second candidate list, and filling the specific-slope CCLM models into the second candidate list until there are N groups of candidate cross-component prediction models.

18. The method of claim 17, further comprising:
in a case where the number of the groups of second cross-component prediction models after de-duplication is equal to N, using the second cross-component prediction models after de-duplication as candidate cross-component prediction models in the second candidate list.

19. The method of claim 17, further comprising:
in a case where the number of the groups of second cross-component prediction models after de-duplication is greater than N, using the second cross-component prediction models after de-duplication as candidate cross-component prediction models in the second candidate list.

20. A bitstream obtained by using the encoding method of claim 1.
